(19) United States
(12) Patent Application Publication
(10) Pub. No.: US 2014/0096270 A1
(43) Pub. Date: Apr. 3, 2014

(54) SECURE DATA CONTAINERS AND DATA ACCESS CONTROL

(71) Applicants: Richard T. Beckwith, Hillsboro, OR (US); Keith L. Shippy, Tempe, AZ (US); Reinhard R. Steffens, Santa Clara, CA (US); Yeugeniy Epshteyn, Portland, OR (US)

(72) Inventors: Richard T. Beckwith, Hillsboro, OR (US); Keith L. Shippy, Tempe, AZ (US); Reinhard R. Steffens, Santa Clara, CA (US); Yeugeniy Epshteyn, Portland, OR (US)

(21) Appl. No.: 13/630,618

(22) Filed: Sep. 28, 2012

(51) Int. Cl. G06F 21/62

(52) U.S. Cl. CPC G06F 21/62
USPC 726/30

(57) ABSTRACT

Various embodiments are generally directed to creating, sharing and various aspects of accessing information that is digitally stored in a data container on one or more computing devices. An apparatus comprises a processor circuit and a storage communicatively coupled to the processor circuit and storing a first sequence of instructions operative on the processor circuit to receive a signal indicating an access to a data container stored in the storage and comprising a protected data and a second sequence of instructions; and execute the second sequence of instructions, the second sequence of instructions operative on the processor circuit to examine security data associated with the apparatus and stored in the storage, and determine whether to grant access to the protected data based on the examination. Other embodiments are described and claimed herein.

### BACKGROUND

As more and more information continues to be stored as data in digital form, longstanding issues of how to protect that information, while still making it conveniently available where it is needed have taken on greater importance. Increasingly, the processes for applying for loans, jobs, licenses, and scholastic programs entail providing personal information in digital form, especially as filling out applications online in a manner that includes uploading of data files (e.g., resumes, scanned copies of transcripts, scanned copies of titles, etc.) becomes commonplace. Increasingly, financial, professional, medical, marketing, business planning, technical and other information about persons and organizations are stored in many different places in digital form (e.g., tax returns, records of diagnoses, bank records, engineering notebooks, trade secrets, meeting minutes, etc.).

Although laws have been promulgated and/or updated in an attempt to discourage theft or misuse of information, such approaches can often do little more than to mitigate the damage done after information has already fallen into the wrong hands. Various security measures have been employed over many years to address these concerns, but have become increasingly difficult to enforce as more information is stored digitally. It has simply become extremely easy to convey digitally-stored information via the Internet and/or via solid-state storage devices that have achieved ever greater storage capacities while also taking ever smaller physical forms. Further, there is an increasing acceptance of storing information in servers at remote locations in a manner accessible via the Internet (e.g., so-called storage of information “in the cloud”) with little more than a password, as well as sending such information as attachments via email. In these cases, the theft or accidental release of a password can result in unauthorized access to a great deal of such information.

Even those who scrupulously avoid storing or conveying information of a sensitive nature in a manner entailing the use of publicly accessible networks may become victims as a result of efforts to carry such information as they may need on solid-state storage devices that they attempt to keep physically protected from access. A single misplaced one of such solid-state storage devices can result in a considerable release of information.

### BRIEF DESCRIPTION OF THE DRAWINGS

FIG. 1 illustrates a first embodiment of interaction among computing devices.

FIG. 2 illustrates a portion of the embodiment of FIG. 1.

FIG. 3 illustrates a portion of the embodiment of FIG. 1.

FIG. 4 illustrates a portion of the embodiment of FIG. 1.

FIG. 5 illustrates a portion of the embodiment of FIG. 1.

FIG. 6 illustrates a portion of the interaction of the embodiment of FIG. 1.

FIG. 7 illustrates an embodiment of a first logic flow.

FIG. 8 illustrates an embodiment of a second logic flow.

FIG. 9 illustrates an embodiment of a third logic flow.

FIG. 10 illustrates an embodiment of a fourth logic flow.

FIG. 11 illustrates an embodiment of a processing architecture.

### DETAILED DESCRIPTION

Various embodiments are generally directed to creating, sharing and various aspects of accessing information that is digitally stored in a data container on one or more computing devices. More specifically, a data structure is defined that comprises a combination of protected data, sequences of instructions controlling and providing different forms of access to the protected data, and security data that may include a public key, a device ID and/or an operator ID. These features of the data structure enable control over access depending on the identity of a computing device, an identity of an operator of that computing device, and what security features are provided by that security device.

The protected data, itself, is encrypted within the data container such that the mechanisms built into the data structure of the data container for controlling access to the protected data cannot be circumvented. Upon use of a computing device to attempt to access the protected data, those mechanisms check various features of that computing device to determine if the data container is in the possession of an authorized operator and/or what limits to impose on access to the data. The results of those checks lead to a determination of whether or not access to the data will be permitted and with what limits.

Limits on access may include the use of only certain editing and/or viewing software to interact with the protected data, or limits imposed on what functions of a computing device are permitted to be used in handling the protected data to prevent copying or compromising of the data in other ways (e.g., creating a printout out the protected data or obtaining a screen capture of a visual presentation of the protected data). Limits on access may also include temporal limits (e.g., a time limit, a date of expiration of access, etc.), and/or situational limits (e.g., access to the Internet required to enable communications with a time server, etc.).

Beyond limits to accessing the protected data, various embodiments may further incorporate hardware-based controls on sharing and/or updating such data containers and/or the protected data they contain. A secure form of ensuring access by an authorized person to protected data may entail recurringly sharing and synchronizing of copies of data containers among numerous computing devices in a specified group that occurs in an opportunistic manner whenever two or more of those computing devices come into communication with each other.

In one embodiment, for example, an apparatus comprises a processor circuit and a storage communicatively coupled to the processor circuit and storing a first sequence of instructions operative on the processor circuit to receive a signal indicating an access to a data container stored in the storage and comprising a protected data and a second sequence of instructions; and execute the second sequence of instructions, the second sequence of instructions operative on the processor circuit to examine security data associated with the apparatus and stored in the storage, and determine whether to grant access to the protected data based on the examination. Other embodiments are described and claimed herein.

With general reference to notations and nomenclature used herein, portions of the detailed description which follows may be presented in terms of program procedures executed on a computer or network of computers. These procedural descriptions and representations are used by those skilled in the art to most effectively convey the substance of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatus may be specially constructed for the required purpose or may comprise a general purpose computer. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives within the scope of the claims.

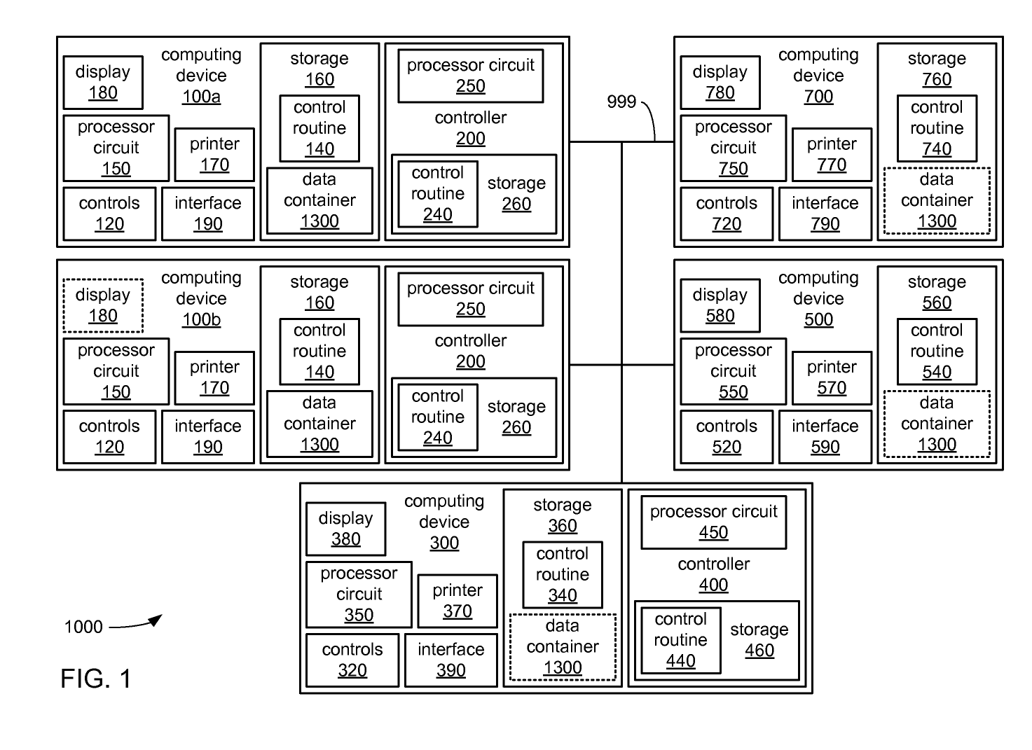

FIG. 1 illustrates a block diagram of a data handling system 1000 comprising one or both of computing devices 100a and 100b employed in creating and editing a data container 1300 by a common operator, and one or more of computing devices 300, 500 and 700 under the control of different other operators to at least view protected data within the data container 1300. Each of the computing devices 100a-b, 300, 500 and 700 may be any of a variety of types of computing device, including without limitation, a desktop computer system, a data entry terminal, a laptop computer, a netbook computer, a tablet computer, an ultrabook, a handheld personal data assistant, a smartphone, a digital camera, a mobile device, a body-worn computing device incorporated into clothing, a computing device integrated into a vehicle, a server, a cluster of servers, a server farm, etc.

As depicted, the computing devices 100a-b, 300, 500 and 700 exchange signals conveying at least copies of the data container 1300 through a network 999, although one or more of these computing devices may exchange other data entirely unrelated to the data container 1300 or the protected data it contains. In various embodiments, the network 999 may be a single network possibly limited to extending within a single building or other relatively limited area, a combination of connected networks possibly extending a considerable distance, and/or may include the Internet. Thus, the network 999 may be based on any of a variety (or combination) of communications technologies by which signals may be exchanged, including without limitation, wired technologies employing electrically and/or optically conductive cabling, and wireless technologies employing infrared, radio frequency or other forms of wireless transmission.

In various embodiments, and as will be explained in greater detail, the computing devices 100a and 100b are owned, used and/or otherwise under the control of a common operator. It should be noted that despite the fact that two of these computing devices of the one common operator are depicted, it is envisioned that this one operator may have numerous others that are used together in a group to enable easy access to data containers (e.g., the data container 1300) as long as the one operator has any one of the computing devices of that group with them. It is only for the sake of simplicity in depiction and discussion that just two of these are depicted. This one operator of the computing devices 100a-b (and of the others of that group) has authored or otherwise possesses data that they wish to convey to certain other persons for use for specific purposes, and therefore, this one operator incorporates this data into the data container 1300 as a protected data, and sends the data container 1300 to operators of the computing devices 300, 500 and 700. What those other operators are able to do with the protected data within the data container 1300 is limited by a combination of who each of those operators are and the security capabilities of their respective ones of the computing devices 300, 500 and 700.

Although various restrictions are imposed on the manner in which the operators of each of the computing device 300, 500 and 700 are able to access or use the protected data within the data container 1300, various security features of the computing devices 100a-b engage in a cooperation among themselves and with security features of the data container 1300 to enable far freer sharing of and access to the protected data contained therein via at least the computing devices 100a-b. Various security measures are employed in configuring the computing devices 100a-b to communicate with each other. With the computing devices 100a-b communicating through the network 999, encryption, virtual private network channels and/or other techniques may be employed to enable communications therebetween that protect whatever information is conveyed. Alternatively, the computing devices 100a-b may reserve communications entailing transmission of portions or the entirety of the data container 1300 therebetween for an entirely separate network (possibly a point-to-point link) among only communications under the control of the single common operator.

In various embodiments, each of the computing devices 100a and 100b comprises a storage 160 storing a control routine 140 and the data container 1300, a processor circuit 150, controls 120, an interface 190 coupling the computing devices 100a-b to the network 999 and/or another network, and a controller 200. Further, one or both of the computing devices 100a and 100b comprise a display 180 and/or a printer 170. The controller 200 of each of the computing devices 100a-b comprises a storage 260 storing a control routine 240, and a processor circuit 250. In executing a sequence of instructions of the control routine 240, the each of the processor circuits 250 are caused to operate the interface 190 to both recurringly attempt to communicate with other computing devices belonging to a specified group of computing devices associated with the operator of the computing devices 100a-b, and to maintain communications with such other computing devices. Also, in executing a sequence of instructions of at least the control routine 140, the processor circuit 150 is caused to monitor the controls 120 to enable an operator of the computing devices 100a-b to operate the controls 120 to signal the processor circuit 150 with a command to access the data container 1300.

As previously mentioned, the computing devices 100a-b are envisioned as being part of a larger group of computing devices all under the control of one operator. In various embodiments, such a group is formed by making use of security features of each of those computing devices in which group device IDs are created and exchanged among them (along with an operator ID associated with this common operator) to enable each of those computing devices to recognize the others as part of that group. By way of example, the computing device 100a is already part of such a group, and the operator of both of the computing devices 100a-b desires to add the computing device 100b to that group. The processor circuit 250 of the computing device 100a responds to operation of the controls 120 signaling a command to provide a group device ID to enable adding another computing device to the group by providing such a group device ID to the operator for manual entry into another computing device. It should be noted that the processor circuit 250 may either monitor the controls 120 directly for such a signal, or the processor circuit 150 may relay such a signal to the processor circuit 250. Provision of the group device ID to the operator may be performed in any of a number of ways, including audibly (spelling out the characters of the device ID with an artificial voice) or visually via the display 180.

Correspondingly, the processor circuit 250 of the computing device 100b responds to operation of the controls 120 signaling manual entry of the group device ID by storing the group device ID within the storage 260 of the computing device 100b, and then attempting to contact the computing device 100a to establish secure communications therebetween. It should be noted that prior to the operator operating the controls 120 either of the computing device 100a to obtain the group device ID or of the computing device 100b to provide the group device ID, the operator was required to authenticate themselves to both of these computing devices. Thus, already stored in the storage 260 of both of these computing devices is an operator ID associated with this common operator of both of these computing devices. In contacting the computing device 100a to establish secure communications therewith, the processor circuit 250 of the computing device 100b is caused to present both the group device ID and operator ID to the computing device 100a as part of gaining acceptance from the computing device 100a to engage in such secure communications. Upon commencement of secure communications, the processor circuit 250 of the computing device 100a transmits group device IDs of other computing devices of the group to the computing device 100b for the processor circuit 250 of the computing device 100b to store in its storage 260 to enable the computing device 100b to recognize still other computing devices that also belong to the group.

At a later time, the operator may be able to remove the computing device 100b from this group in one of two ways. Where this operator still has access to the computing device 100b, the operator operates the controls 120 of the computing device 100b to signal it with a command to remove itself from the group. The processor circuit 250 of the computing device 100b responds to receipt of this signal by the computing device 100b by deleting the group device IDs stored in the storage 260 for itself and other computing devices of the group, thereby removing its ability to present itself as a member of the group or to recognize other computing devices of the group. Further, the processor circuit 150 may respond to the receipt of this signal by erasing data received from other computing devices of the group, including data contained within data containers, such as the data container 1300. Alternatively, where this operator does not still have access to the computing device 100b (e.g., where the computing device 100b may have been misplaced or stolen), this operator operates the controls 120 of the computing device 100a to command it to remove the computing device 100b as a member of the group. In response, the processor circuit 250 of the computing device 100a deletes the group device ID of the computing device 100b from the storage 260, and relays a signal to other computing devices of the group to do likewise. Although this may not address the issue of whatever data has already been conveyed to the computing device 100b, it does serve to prevent the computing device 100a and other computing devices of the group from transmitting more data to the computing device 100b should any of these computing devices once again come into contact with the computing device 100b.

Regardless of the exact manner or exact procedure by which the computing devices 100a-b are caused to be members of a common group by which these two computing devices 100a-b are caused to engage in secure communications as monitored by respective ones of their processor circuits 250, the fact of their membership in this same group and of occurrences of secure communications therebetween triggers the processor circuits 150 of these two computing devices to cooperate to recurringly compare their respective copies of the data container 1300 to synchronize them. In other words, in response to changes made to the contents of one of these copies of the container 1300, the processor circuits 150 are caused by their respective ones of the control routine 140 to recurringly transmit those changes between these two computing devices to enable updating of the contents of the other of these copies of the data container 1300.

As previously discussed, it is envisioned that the computing devices 100a-b may merely be two of numerous computing devices in a group. As such, it is envisioned that this common operator of these numerous computing devices is apt to have at least one of these computing devices with them constantly enough as to have ready access to the data within the data containers that are maintained and recurringly synchronized among those computing devices. Some of these computing devices may provide relatively complete user interfaces enabling the operator to access and interact with such data using such a user interface. However, it is also envisioned that others of these computing devices may be lacking in such complete user interfaces such that although these other computing devices may carry data containers and participate in synchronization processes to keep their contents up to date, these other computing devices do not provide for being operated to actually interact with that data. Instead, it is envisioned that these other computing devices lacking in such a user interface primarily serve as vehicles to convey data containers between still other computing devices that do provide such a complete user interface. Thus, as hinted at by the dotted lines employed in depicting the display 180 of the computing device 100b, it may be that the computing device 100a provides a sufficient user interface as to enable the operator to interact with the data within the data container 1000 (e.g., viewing and/or editing that data), while it may be that the computing device 100b lacks the display 180 and/or other components of a sufficient user interface such that the computing device 100b serves more as a carrier of the data container 1300 and not as a tool for interacting with the data therein.

In various embodiments, a system of sets of public and private keys is employed in controlling access to the data within the data container 1300. Within the data container 1300 is a public key and an executable sequence of instructions that attempts to match that public key to private keys carried by different computing devices, at least at times when attempts are made to access the data within the data container 1300. In the case of the computing devices 100a-b, such private keys are stored in the storages 260 of each, where corresponding ones of the processor circuits 250 are able to retrieve them and make them available for use in such comparisons, either directly or through using them to generate signatures. It should be noted, and as will be discussed in greater detail, such use of keys serves the purpose of authenticating the level of security provided by a computing device, and not necessarily the identity of either a particular computing device or of a particular person associated with a computing device. It should also be noted that although the use of public and private keys is discussed in some detail herein as an authentication mechanism, other mechanisms of authentication may be used in addition to or in lieu of the use of public and/or private keys.

In various embodiments, to distinguish between computing devices and/or persons associated with them, such use of keys may be augmented with the use of device IDs identifying particular computing devices and/or operator IDs identifying particular persons associated with those computing devices. Thus, within the data container 1300 may also be device IDs and/or operator IDs (in addition to a public key) and an executable sequence of instructions that attempts to match one or both to corresponding ones carried by different computing devices. Presuming that the operator of the computing devices 100a-b (and whatever others may be in the group to which both belong) is the person who created the data container 1300 as part of authoring the data within it, the private key, operator ID and/or device IDs stored within the storages 260 of each of the computing devices 100a-b would presumably match those maintained within the container 1300. Therefore, were the operator of the computing devices 100a-b to operate the controls 120 of the computing device 100a to access the data within the data container 1300, for example, the operator would presumably have unrestricted access to do as they like with that data. As will be explained in greater detail, such security measures as comparing keys, operator IDs and/or device IDs, along with other security provisions, may be employed as inputs to security policies maintained as part of data containers to enable automated determination of whether access to data is to be granted and/or with what restrictions.

In various embodiments, the computing device 300 has many of the security features of each of the computing devices 100a and 100b, but is under the control of a different operator. Thus, the computing devices 300 comprises a storage 360 storing a control routine 340, a processor circuit 350, controls 320, a display 380, a printer 370, an interface 390 coupling the computing device 300 to the network 999 and/or another network, and a controller 400. The controller 400 comprises a storage 460 storing a control routine 440, and a processor circuit 450. In executing a sequence of instructions of the control routine 440, the processor circuit 450 is caused to be ready to provide a private key, an operator ID associated with the operator of the computing device 300, and/or a device ID associated with the computing device 300 in response to queries caused to occur in response to the operator of the computing device 300 attempting to access data in various data containers.

As depicted with dotted lines within the storage 360, the computing device 300 may receive the data container 1300, possibly via the network 999. It may be that the operator of the computing devices 100a-b, after authoring the data within the data container 1300, has sent the data container 1300 to the operator of the computing device 300 to at least view the data within. In response to the operator of the computing device 300 accessing the data container 1300, an executable sequence of instructions of the data container 1300 causes the processor circuit 350 to seek one or more of a private key, an operator ID and a device ID, and the processor circuit 450 is caused by the control routine 440 to cooperate by providing one or more of these from the storage 460. Given that the computing device 300 has very much the same security features as either of the computing devices 100a-b, the private key maintained in the storage 460 is presumably a match to the public key maintained in the data container 1300, thereby verifying that the computing device 300 provides an environment that is trustworthy to some degree for various security policies to be honored.

It should be noted that manufacturers of the computing devices 100a-b and 300 may be provided with private keys to accompany the controllers 200 and 400 to establish, in response to queries caused to be made by executable code of data containers, that a trustworthy environment is provided that includes hardware-based security features (e.g., various security functions provided by the controllers 200 and 400) creating an environment within the computing device 300 that ensures that various security policies dictated by policy data within those data containers will not be violated. By way of example, a access policy dictated by policy data within a data container may include a prohibition against the data within that data container being printed on a printer of a computing device (e.g., the printer 370), and the security features provided by the controller 400 may include automatically interceding to prevent any attempt by the operator of the computing device 300 to use the printer 370 to do so. By way of another example, a access policy dictated by policy data within a data container may include a requirement that various techniques be employed to ensure that the data within the container does not continue to be displayed on the display 380 at times when the operator of the computing device 300 is no longer present at the computing device 300 such that someone else may be able to view it, and the security features provided by the controller 400 may include continuously monitoring the controls 320 for instances of a lack of activity at those controls lasting longer than a specified amount of time such that it is presumed that the operator of the computing device 300 is no longer present, thereby causing the controller 400 to lock the computing device 300 until its operator returns and unlocks it. It is envisioned that the controllers 200 and 400 are accessible to the processor circuits 150 and 350, respectively, in a manner that is sufficiently limited that the controllers 200 and 400 are largely isolated from attempts made by malicious software that may be executed by the processor circuits 150 and 350 to defeat the security functions provided by the controllers 200 and 400. Thus, the fact of the provision of a private key that matches the public key maintained by the data container 1300 may, therefore, confirm the presence of such an isolated component, and this may be employed as a factor by executable code of the data container 1300 in determining that some degree of greater access to the data within the data container 1300 may be allowed.

However, although a private key may be provided in response to queries caused to be made by the processor circuit 350 in executing code of the data container 1300 that verifies the provision of a higher level of security, the fact that the computing device 300 is a different computing device from either the computing devices 100a-b and the fact that the computing device 300 is operated by a different person results in any operator ID and device ID provided in response to such queries not matching those that would be expected from either of the computing device 100a-b. Therefore, access to the data within the container to the extent of being able to edit and/or print it may not be granted. However, presuming that the operator of the computing devices 100a-b chose to send the data container 1300 to the operator of the computer device 300, the operator ID provided by the processor circuit 450 in response to such queries would presumably reveal that the operator of the computing device 300 is an intended recipient of the data container 1300, and should therefore be granted some degree of access.

It should be noted that the security policies of the data container 1300 would have been selected by the operator of the computing devices 100a-b while creating and/or editing the data container 1300 and the data within it. Therefore, presuming that the operator of the computing devices 100a-b intended to provide the data container 1300 to the operator of the computing device 300, the operator of the computing devices 100a-b would have set the security policies of the data container 1300 to permit the operator of the computing device 300 to have access to the data within, either triggered by the provision of an operator ID associated with the operator of the computing device 300 or by the provision of a device ID associated with the computing device 300, itself. It should further be noted that the operator ID may be associated with all persons belonging to a group of persons, such as a family, a business or other of organization. This would enable the author of a data container to specify a access policy in which access would be granted to persons of that family, that business or that other type of organization, without having to specify operator IDs for each person.

In various embodiments, the computing device 500, as can be seen in FIG. 1, lacks at least some of the security features of each of the computing devices 100a-b and 300. More specifically, the computing devices 500 comprises a storage 560 storing a control routine 540, a processor circuit 550, controls 520, a display 580, a printer 570, and an interface 590 coupling the computing device 500 to the network 999 and/or another network. However, the computing device 500 does not comprise a controller such as the controllers 200 or 400 of the computing devices 100a-b or 300, respectively. In executing a sequence of instructions of the control routine 540, the processor circuit 550 (and not a separate processor circuit of a controller) is caused to be ready to provide a private key, an operator ID associated with the operator of the computing device 500, and/or a device ID associated with the computing device 500 in response to queries caused to occur in response to the operator of the computing device 500 attempting to access data in various data containers.

Given the lack of the hardware-based security features that accompanies the lack of such a separate hardware controller to provide them, the private key that the processor circuit 550 is ready to provide may be a private key that indicates the lesser provision of security features, and it may be that the data container 1300 comprises another public key that the private key of the computing device 500 would match, thereby verifying the provision of some degree of security features, but not to the same degree as the computing devices 100a-b or 300. By way of example, the processor circuit 550 may be caused by execution of the control routine 540 to provide a software-based secure environment (e.g., some form of virtual environment) in which execution of code embedded in the data container 1300 would occur in under controlled conditions that would provide some degree of protection against malicious software intervening in a manner enabling compromise of the data within the data container 1300. However, the control routines 340 and 440 of the computing device 300 may be capable of causing the processor circuits 350 and 450, respectively, to cooperate to provide such an environment in which code embedded in the data container 1300 is executed by the processor circuit 350 with the processor circuit 450 overseeing such execution to be prepared to intercede to block intrusions into that environment by other software that may also be executed by the processor circuit 350. Thus, while both of the computing devices 300 and 500 may provide secured environments, the hardware-based security features of the computing device 300 may provide that type of security to a greater degree.

Depending on the access policy choices made by the operator of the computing devices 100a-b, the provision of a private key indicative of a lower level of security may be employed as a factor by executable code of the data container 1300 in determining the degree of access to the data within. By way of example, the access granted may entail allowing only viewing of the data using viewing software embedded within the container 1300, rather than allowing the operator of the computing device 500 to use other viewing software present in the storage 560. Presuming that the operator of the computing devices 100a-b chose to send the data container to the operator of the computing device 500, the operator ID provided by the processor circuit 550 and associated with the operator of the computing device 500 would presumably result in granting of access to the data within the storage container 1300.

In various embodiments, the computing device 700, like the computing device 500, similarly lacks the hardware-based security features of each of the computing devices 100a-b and 300. More specifically, the computing devices 700 comprises a storage 760 storing a control routine 740, a processor circuit 750, controls 720, a display 780, a printer 770, and an interface 790 coupling the computing device 700 to the network 999 and/or another network. In executing a sequence of instructions of the control routine 740, the processor circuit 750 is caused to be ready to provide an operator ID associated with the operator of the computing device 700 and/or a device ID associated with the computing device 700 in response to queries caused to occur in response to the operator of the computing device 700 attempting to access data in various data containers. However, unlike the computing device 500, the control routine 740 does not cause the processor circuit 750 to be ready to provide a private key in response to queries for one. This is reflective of the control routine 740 not causing the processor circuit 750 to provide a software-based secure environment for execution of code embedded within the container 1300.

Presuming that the operator of the computing devices 100a-b chose to provide the data container 1300 to the operator of the computing device 700, the provision of an operator ID associated with the operator of the computing device 700 may be enough to cause access to the data within the data container 1300 to be granted, but the access may be specified by the access policy selected by the operator of the computing devices 100a-b to be highly restrictive. By way of example, possibly only a subset of the data within the data container 1300 may be made accessible, and that access may be a highly restrictive form of viewing access in which possibly only small portions of the accessible data are ever shown at any given time in an effort to make printing of that data more time consuming so as to discourage it. By way of another example, access to data within the data container 1300 may be time limited in some manner. It may be that a countdown of a specified number of days may be triggered with the first occasion on which the data is accessed using the computing device 700 (or, possibly a specified number of days after the data container 1300 is first stored within the computing device 700) such that the data container 1300 refuses to ever again provide such access after that number of days has ended. Or, it may be that the ability to access the data is set to expire upon the arrival of a date selected by the operator of the computing devices 100a-b.

In various embodiments, each of the processor circuits 150, 250, 350, 450, 550 and 750 may comprise any of a wide variety of commercially available processors, including without limitation, an AMD® Athlon®, Duron® or Opteron® processor; an ARM® application, embedded or secure processor; an IBM® and/or Motorola® DragonBall® or PowerPC® processor; an IBM and/or Sony® Cell processor; or an Intel® Celeron®, Core (2) Duo®, Core (2) Quad®, Core i3®, Core i5®, Core i7®, Atom®, Itanium®, Pentium®, Xeon® or XScale® processor. Further, one or more of these processor circuits may comprise a multi-core processor (whether the multiple cores coexist on the same or separate dies), and/or a multi-processor architecture of some other variety by which multiple physically separate processors are in some way linked.

In various embodiments, each of the storages 160, 260, 360 460, 560 and 760 may be based on any of a wide variety of information storage technologies, possibly including volatile technologies requiring the uninterrupted provision of electric power, and possibly including technologies entailing the use of machine-readable storage media that may or may not be removable. Thus, each of these storages may comprise any of a wide variety of types (or combination of types) of storage device, including without limitation, read-only memory (ROM), random-access memory (RAM), dynamic RAM (DRAM), Double-Data-Rate DRAM (DDR-DRAM), synchronous DRAM (SDRAM), static RAM (SRAM), programmable ROM (PROM), erasable programmable ROM (EPROM), electrically erasable programmable ROM (EEPROM), flash memory, polymer memory (e.g., ferroelectric polymer memory), ovonic memory, phase change or ferroelectric memory, silicon-oxide-nitride-oxide-silicon (SONOS) memory, magnetic or optical cards, one or more individual ferromagnetic disk drives, or a plurality of storage devices organized into one or more arrays (e.g., multiple ferromagnetic disk drives organized into a Redundant Array of Independent Disks array, or RAID array). It should be noted that although each of these storages is depicted as a single block, one or more of these may comprise multiple storage devices that may be based on differing storage technologies. Thus, for example, one or more of each of these depicted storages may represent a combination of an optical drive or flash memory card reader by which programs and/or data may be stored and conveyed on some form of machine-readable storage media, a ferromagnetic disk drive to store programs and/or data locally for a relatively extended period, and one or more volatile solid state memory devices enabling relatively quick access to programs and/or data (e.g., SRAM or DRAM). It should also be noted that each of these storages may be made up of multiple storage components based on identical storage technology, but which may be maintained separately as a result of specialization in use (e.g., some DRAM devices employed as a main storage while other DRAM devices employed as a distinct frame buffer of a graphics controller). Further, the storage 160 may be at least partially based on remote storage accessible via a network (e.g., a network-attached storage (NAS) device, a network-accessible server maintaining a backup copy of the contents of a more local portion of the storage 160, etc.).

In various embodiments, each of the interfaces 190, 390, 590 and 790 employ any of a wide variety of signaling technologies enabling each of computing devices 100a-b, 300, 500 and 700 to be coupled through the network 999 as has been described. Each of these interfaces comprises circuitry providing at least some of the requisite functionality to enable such coupling. However, each of these interfaces may also be at least partially implemented with sequences of instructions executed by corresponding ones of the processor circuits 150, 350, 550 and 750 (e.g., to implement a protocol stack or other features). Where one or more portions of the network 999 employs electrically and/or optically conductive cabling, corresponding ones of the interfaces 190, 390, 590 and 790 may employ signaling and/or protocols conforming to any of a variety of industry standards, including without limitation, RS-232C, RS-422, USB, Ethernet (IEEE-802.3) or IEEE-1394. Alternatively or additionally, where one or more portions of the network 999 entails the use of wireless signal transmission, corresponding ones of the interfaces 190, 390, 590 and 790 may employ signaling and/or protocols conforming to any of a variety of industry standards, including without limitation, IEEE 802.11a, 802.11b, 802.11g, 802.16, 802.20 (commonly referred to as “Mobile Broadband Wireless Access”); Bluetooth; ZigBee; or a cellular radiotelephone service such as GSM with General Packet Radio Service (GSM/GPRS), CDMA/1xRTT, Enhanced Data Rates for Global Evolution (EDGE), Evolution Data Only/Optimized (EV-DO), Evolution For Data and Voice (EV-DV), High Speed Downlink Packet Access (HSDPA), High Speed Uplink Packet Access (HSUPA), 4G LTE, etc. It should be noted that although each of the interfaces 190, 390 and 590 are depicted as a single block, one or more of these may comprise multiple interfaces that may be based on differing signaling technologies. This may be the case especially where one or more of these interfaces couples corresponding ones of the computing devices 100a-b, 300, 500 and 700 to more than one network, each employing differing communications technologies.

In various embodiments, each of the controls 120, 320, 520 and 720 may comprise any of a variety of types of manually-operable controls, including without limitation, lever, rocker, pushbutton or other types of switches; rotary, sliding or other types of variable controls; touch sensors, proximity sensors, heat sensors or bioelectric sensors, etc. Each of these controls may comprise manually-operable controls disposed upon a casing of corresponding ones of the computing devices 100a-b, 300, 500 and 700, and/or may comprise manually-operable controls disposed on a separate casing of a physically separate component of corresponding ones of these computing devices (e.g., a remote control coupled to other components via infrared signaling). Alternatively or additionally, each of these controls may comprise any of a variety of non-tactile user input components, including without limitation, a microphone by which sounds may be detected to enable recognition of a verbal command; a camera through which a face or facial expression may be recognized; an accelerometer by which direction, speed, force, acceleration and/or other characteristics of movement may be detected to enable recognition of a gesture; etc.

In various embodiments, each of the displays 180, 380, 580 and 780 may be based on any of a variety of display technologies, including without limitation, a liquid crystal display (LCD), including touch-sensitive, color, and thin-film transistor (TFT) LCD; a plasma display; a light emitting diode (LED) display; an organic light emitting diode (OLED) display; a cathode ray tube (CRT) display, etc. Each of these displays may be disposed on a casing of corresponding ones of the computing devices 100a-b, 300, 500 and 700, or may be disposed on a separate casing of a physically separate component of corresponding ones of these computing devices (e.g., a flat panel monitor coupled to other components via cabling).

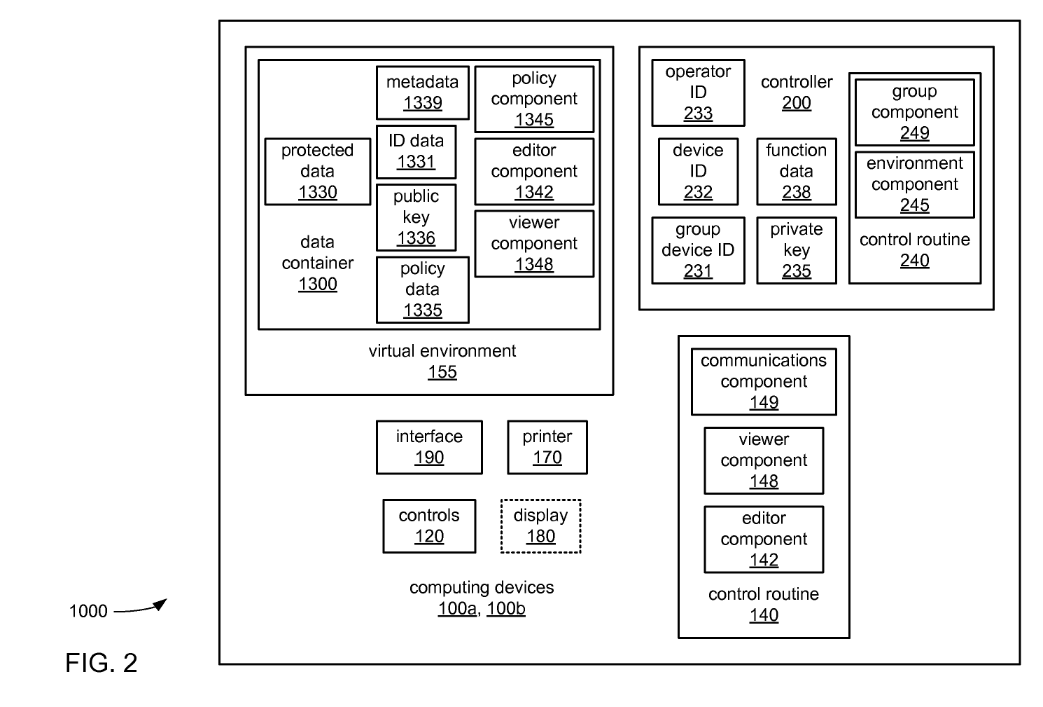

FIGS. 2, 3, 4 and 5, taken together, illustrate block diagrams of portions of the block diagram of FIG. 1 depicted in greater detail. More specifically, aspects of the operating environments of the computing devices 100a-b, 300, 500 and 700 are depicted, in which corresponding ones of the processor circuits 150, 250, 350, 450, 550 and 750 (FIG. 1) are caused by execution of respective control routines 140, 240, 340, 440, 540 and 740 to perform the aforedescribed functions. As will be recognized by those skilled in the art, each of the control routines 140, 240, 340, 440, 540 and 740, including the components of which each is composed, are selected to be operative on whatever type of processor or processors that are selected to implement each of the processor circuits 150, 250, 350, 450, 550 and 750.

Also, each of FIGS. 2-5 depicts aspects of the contents of the data container 1300 in greater detail. Specifically, the data container 1300 comprises a protected data 1330, an ID data 1331, a policy data 1335, a public key 1336, a metadata 1339, an editor component 1342, a policy component 1345 and a viewer component 1348. It is the protected data 1330 for which the data container 1300 is created to protect and control access to. The metadata 1339 provides a short description of the protected data 1330 or aspect of the protected data 1330 (e.g., a name of its author(s), subject to which the protected data 1330 relates, etc.).

In various embodiments, one or more of the control routines 140, 240, 340, 440, 540 and 740 may comprise a combination of an operating system, device drivers and/or application-level routines (e.g., so-called “software suites” provided on disc media, “applets” obtained from a remote server, etc.). Where an operating system is included, the operating system may be any of a variety of available operating systems appropriate for whatever corresponding ones of the processor circuits 150, 250, 350, 450, 550 and 750, including without limitation, Windows™, OS X™, Linux®, or Android OS™. Where one or more device drivers are included, those device drivers may provide support for any of a variety of other components, whether hardware or software components, that comprise one or more of the computing devices 100a-b, 300, 500 and 700.

Each of the control routines 140, 340, 540 and 740 comprises a communications component 149, 349, 549 and 749, respectively, executable by corresponding ones of the processor circuits 150, 350, 550 and 750 to operate corresponding ones of the interfaces 190, 390, 590 and 790 to transmit and receive signals via the network 999 as has been described. As will be recognized by those skilled in the art, each of the communications components 149, 349, 549 and 749 are selected to be operable with whatever type of interface technology is selected to implement each of the interfaces 190, 390, 590 and 790.

Each of the control routines 140, 340, 540 and 740 comprises an editor component 142, 342, 542 and 742, respectively, executable by corresponding ones of the processor circuits 150, 350, 550 and 750 to employ the controls 120, 320, 520 and 720, and with the displays 180, 380, 580 and 780 to enable operators of the computing devices 100a-b, 300, 500 and 700 to author and edit data, including data incorporated into data containers (subject to access restrictions as discussed herein). Thus, the operator of the computing devices 100a and 100b may have created the data container 1300 and the protected data 1330 within using the editor component 142, through use of the controls 120 and the display 180. Further, in creating the data container 1300, the operator of the computing devices 100a-b may have also used the editor component 142 to create the policy data 1335 specifying the varying degrees of access to the protected data 1330 to be granted to one or more specific persons (or groups of persons) under various specified circumstances.

Each of the control routines 140, 340, 540 and 740 comprises a viewer component 148, 348, 548 and 748, respectively, executable by corresponding ones of the processing circuits 150, 350, 550 and 750 to employ the controls 120, 320, 520 and 720, and with the displays 180, 380, 580 and 780 to enable operators of the computing devices 100a-b, 300, 500 and 700 to view data, including data incorporated into data containers (again, subject to access restrictions as discussed herein). Thus, where the operator of the computing devices 100a-b grants access to another person (or to a group of persons) that includes using a viewing software of their choice, that other person may be permitted in the policy data 1335 to employ a viewer component of their computing device to view the 1330. Alternatively, the operator of the computing devices 100a-b may require others to view the protected data 1330 using only a specific viewer component.

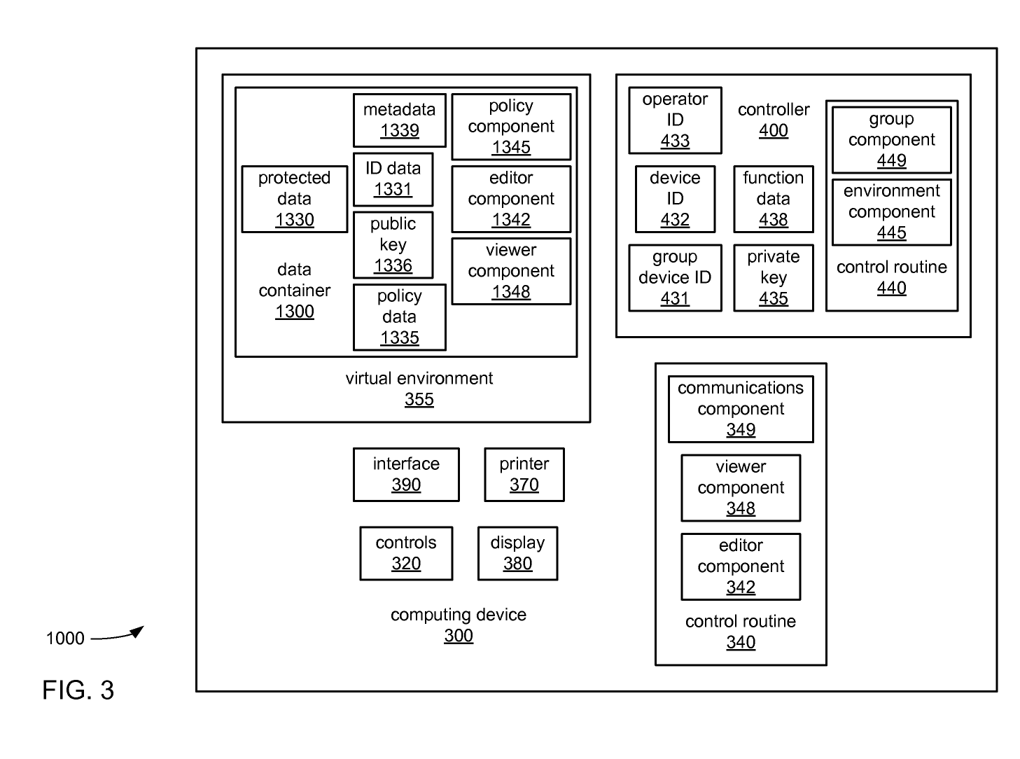

Turning more specifically to FIGS. 2 and 3, each of the control routines 240 and 440 of the controllers 200 and 400 comprise a group component 249 and 449, respectively, executable by corresponding ones the processor circuits 250 and 450 to establish and maintain memberships and security in groups of computing devices to which one or more of the computing devices 100a-b and/or 300 may belong. The processor circuits 250 and 450 are caused by the group components 249 and 449 to monitor the controls 120 and 320, respectively, for instances of operation of those controls signaling entry of a command to provide a device ID or entry of a device ID provided by another computing device to expand a group, or entry of a command to remove a computing device from a group.

Returning to the earlier-presented example of adding the computing device 100b to a group including the computing device 100a, in response to operation of the controls 120 signaling a command to provide a group device ID with which to add another computing device (e.g., the computing device 100b), the processor circuit 250 of the computing device 100a generates and provides a group device ID to be manually entered into another computing device (e.g., the computing device 100b). Again, such provision of a group device ID may entail displaying it on the display 180 for the operator to read. Then, in response to operation of the controls 120 signaling entry of that group device ID, the processor circuit 250 of the computing device 100b stores the entered group device ID as a group device ID 231 in the storage 260 of the computing device 100b. Further, also in response to entry of the group device ID, one or both of the processor circuits 150 and 250 of the computing device 100b operate the interface 190 to contact the computing device 100a to establish secure communications therebetween. It should be noted that before the operator operated the controls 120 of the computing devices 100a and 100b to obtain and then enter a group device ID, the operator was required to authenticate themselves to both of these computing devices, and an operator ID 233 associated with that operator is stored in the storages 260 of both of these computing devices. It should be noted that while the group device ID 231 is different and unique for each of the computing devices 100a and 100b, the operator ID 233 is the same. In contacting the computing device 100a to establish secure communications therewith, the processor circuit 250 of the computing device 100b is caused to present both its group device ID 231 and the operator ID 233 to the computing device 100a as part of gaining acceptance from the computing device 100a to engage in such secure communications. Upon commencement of secure communications, the processor circuit 250 of the computing device 100a is caused to operate its respective interface 190 to transmits group device IDs of other computing devices of the group to the computing device 100b for the processor circuit 250 of the computing device 100b to store in its storage 260 to enable the computing device 100b to recognize still other computing devices that also belong to the group.

At a later time, where the operator chooses to remove the computing device 100b from this group, the operator may operate the controls 120 of the computing device 100b to signal it with a command to remove itself from the group. In response to signal, the processor circuit 250 of the computing device 100b deletes its own group device ID 231 along with any group device IDs stored in the storage 260 for other computing devices of the group, thereby removing its ability to present itself as a member of the group or to recognize other computing devices of the group. Further, the processor circuit 150 may respond to the receipt of this same signal by erasing data received from other computing devices of the group, including data contained within data containers, such as the protected data 1330 of the data container 1300. Alternatively, where this operator does not still have access to the computing device 100b, the operator may operate the controls 120 of the computing device 100a to command it to remove the computing device 100b as a member of the group. In response, the processor circuit 250 of the computing device 100a deletes the group device ID of the computing device 100b from the storage 260, and relays a signal to other computing devices of the group to do likewise, thus preventing the computing device 100a and any of the other computing devices of the group from recognizing the computing device 100b as a member of the group. It should be noted that although these two particular mechanisms of removing a computing device from a group are presented in detail, other mechanisms for doing so may also be employed, either in addition to or in lieu of one or both of these specifically detailed mechanisms.

While the computing devices 100a and 100b are members of the same group such that they engage in secure communications with each other, the processor circuits 150 of these two computing devices cooperate to recurringly compare their respective copies of the data container 1300 stored in the storage 160 to synchronize them such that any changes occurring to one of these copies will be reflected in the other copy.

Each of the control routines 240 and 440 of the controllers 200 and 400 comprise an environment component 245 and 445, respectively, executable by corresponding ones the processor circuits 250 and 450 to cause each to cooperate with the processor circuits 150 and 350, respectively, to provide virtual environments 155 and 355. In each of the virtual environments 155 and 355, executable code embedded in data containers may be executed by the processor circuits 150 and 350, respectively, with the processor circuits 250 and 450 assisting in securing these virtual environments. Specifically, the processor circuits 250 and 450 may intercept attempted actions caused by other software that could result in a violation of an access policy dictated by policy data embedded in a data container (e.g., an attempt to perform a screen capture of displayed data, or to print out data). Further, the processor circuits 250 and 450 may enforce various security requirements specified by a data container, such as monitoring activity associated with an operator being present in the vicinity of a computing device for instances in which a selected period of time has elapsed since such activity was last detected (e.g., operating the controls 120 or 320), and may be caused to respond by locking the computing devices 100a-b and 300, respectively, until their operators return and unlock them.

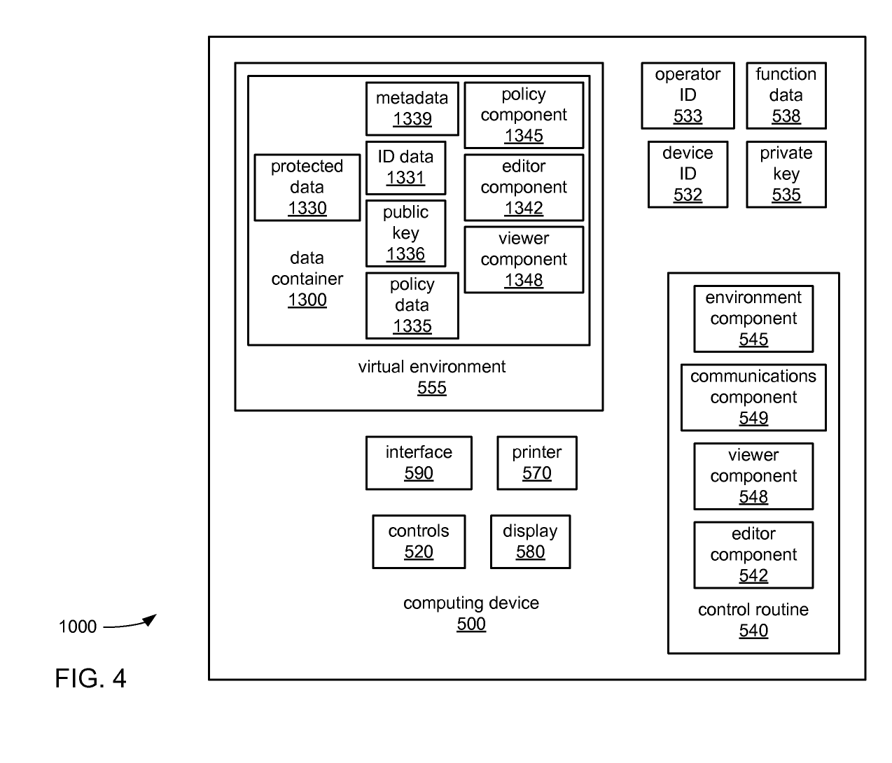

Turning to FIG. 4, the control routine 540 comprises an environment component 545 executable by the processor circuit 550 to provide a virtual environments 555, in which executable code embedded in data containers may be executed by the processor circuit 550 with the benefit of security features provided by the processor circuit 550. Specifically, the processor circuit 550 may intercept attempted actions caused by other software that could result in a violation of a access policy dictated by policy data embedded in a data container, and may enforce various security requirements specified by that policy data. However, unlike the virtual environments 155 and 355, in which separate processor circuits 250 and 450, respectively, provided a degree of hardware-based isolation between execution of data container code and execution of environment components, the provision of the virtual environment 555 in which data container code is executed and the provision of security features are both performed by the processor circuit 550. This results in a somewhat less secure environment in which to execute code embedded in a data container, though this still results in a more secure environment than would exist without the provision of such a virtual environment.

Returning to the depiction of the contents of the data container 1300 in each of FIGS. 2-5, as has been discussed, the data container 1300 incorporates executable code in the form of sequences of instructions operative on the processor circuits 150, 350, 550 and 750. Further, the data container 1300 may incorporate different versions of those sequences of instructions that are executable on different ones of these processor circuits to address the possibility of one or more of these processor circuits having instruction sets that are too different from the others to enable a single sequence of instructions being operative on all of them.

The policy component 1345 comprises one or more executable sequences of instructions that the processor circuits 150, 350, 550 and 750 are caused to execute upon the operators of the computing devices 100a-b, 300, 500 and 700 attempting to access the protected data 1330 within the data container 1300. It is the policy component that causes these processor circuits to perform queries of various aspects of their respective computing devices as part of determining the computing device and/or operator identity, and determining what provisions for security exist. More specifically, the policy component 1345 requests one or more pieces of security data, including and not limited to an operator and/or device ID, a private key assigned to a computing device, and indications of computing device security features. The policy component then employs the responses to these queries in determining whether access is to be granted to the data 1300, and to what degree that access (if granted) is to be limited by the access policy specified in the policy data 1335, as authored by the operator of the computing devices 100a-b.

The editor component 1342 comprises one or more executable sequences of instructions operative on one or more of the processor circuits 150, 350, 550 and 750 to serve as editing software for use by an operator of a computing device who has been granted access to the protected data 1330 to a degree that includes being permitted to edit the protected data 1330. The viewer component 1348 comprises one or more executable sequences of instructions operative on one or more of the processor circuits 150, 350, 550 and 750 to serve as viewing software for use by an operator of a computing device who has been granted access to the protected data 1330 to a degree that includes being permitted to view the protected data 1330, but perhaps not to edit the protected data 1330.

Turning briefly to FIG. 2, operation of the controls 120 of the computing devices 100a-b to access the protected data 1330 of the data container 1300 results in the processor circuit 150 executing the policy component 1345, causing the processor circuit 150 to request security data including one or more of an operator ID, a device ID, a private key and an indication of the security features of the computing device 100a. What exactly is requested may be dictated by access policy specified in the policy data 1335. For example, if the policy data 1335 specifies that access to the protected data 1330 is contingent upon the identity of the user, then the operator ID is requested. Alternatively, if the policy data 1335 specifies that access to the protected data 1330 can only be had through use of particular computing devices, then the device ID is requested. The processor circuit 250 of the controller 200 responds to the request for security data by providing one or more of a device ID 232, an operator ID 233, a private key 235 and a function data 238, depending on what was requested. The policy component 1345 then compares the operator ID 233 and/or the device ID 232 to the ID data 1331 that identifies authorized operator IDs and/or device IDs, and determines whether the private key 235 is a match to the public key 1336.

Given that the protected data 1330 and the data container 1300 was authored by the operator of the computing device 100a, and presuming that the request included a request for an operator ID, the provision of the operator ID 233 associated with this operator presumably would result in this operator being granted relatively unrestricted access, including editing access. Further, the provision of the private key 235 verifying the provision of a higher level of security by the computing device 100a, including the provision of the controller 200 able to provide various hardware-based security features, may cause the policy component 1345 (as directed by the policy data 1335) to grant more thoroughly unrestricted access such that the operator may be permitted to have editing access to the policy data 1335, or may be permitted to use the editor component 142 (which may be an editor that the operator prefers) to edit the protected data 1330 versus being required to use the editor component 1342. The provision of the private key 235 verifying the provision of a higher level of security may also result in the policy component 1345 trusting the veracity of the operator ID 233 and whatever indications of security features are provided by the function data 238, since they are maintained and provided by the processor circuit 250, which is isolated to at least some degree from the rest of the computing device 100a, as has been previously discussed. Without the provision of the private key 235, or with the provision of a different variant of the private key 235 that verifies the provision of only a lower level of security, the policy component 1345 may be caused by the access policy specified in the policy data 1335 to require the entry of a password or other proof that it really is the operator of the computing devices 100a-b who is attempting to access the protected data 1330.

Turning briefly to FIG. 3, operation of the controls 320 of the computing device 300 to access the protected data 1330 of the data container 1300 results in the processor circuit 350 executing the policy component 1345, causing the processor circuit 350 to request security data including one or more of an operator ID, a device ID, a private key and an indication of the security features of the computing device 300. The processor circuit 450 of the controller 400 responds to the request by providing one or more of a device ID 432, an operator ID 433, a private key 435 and a function data 438, depending on what was requested. The policy component 1345 then compares the operator ID 433 and/or the device ID 432 to the ID data 1331, and determines whether the private key 435 is a match to the public key 1336.

As previously discussed, the computing device 300 provides a higher level of security comparable to that of the computing devices 100a and 100b (including the provision of the controller 400 to provide various hardware-based security features), and this is verified by the private key 435 being determined to match the public key 1336. As a result, and depending on the access policy specified in the policy data 1335, the policy component 1345 may deem the identity of the operator of the computing device 300 specified by the operator ID 433 to be trustworthy enough to rely upon, as well as what security features the computing device 300 is indicated as having in the function data 438.

Presuming that the operator of the computing devices 100a-b chose to provide some degree of editing access to a subset of the protected data 1330 to the operator of the computing device 300, the fact of the provision of a higher level of security may result in the policy component permitting the operator of the computing device 300 to edit that subset using the editor component 342 of the computing device 300, instead of requiring use of the editor component 1342. This may be partially due to the ability of the controller 400 to enforce a policy specified in the policy data 1335 in which printing of the protected data 1330 is not permitted by using its role in supporting the provision of the virtual environment 355 to intercede and prevent attempts to print the protected data 1330. Other hardware-based security features may include the use of buses and/or wireless links incorporating protocols to maintain control over what is done with data sent to devices coupled to the computing device 300 via those buses and/or wireless links (e.g., a high-definition multimedia interface (HDMI) wired connection to a display, or a Wireless Display (WiDi) wireless link to a display). Still other hardware-related restrictions may be specified in the policy data 1335, such as a restriction against storing part of all of the data container 1300 in network-attached storage or other supplementary storage device coupled via a network at all, or unless the hardware-based security features include encryption of whatever part of the data container 1300 is stored in such remote storage. If the computing device 300 did not incorporate the controller 400 such that there is no such a hardware-based ability to enforce such a security policy, then the operator of the computing device 300 might have been required by the policy component 1345 to use the editor component 1342.

Turning briefly to FIG. 4, operation of the controls 520 of the computing device 500 to access the protected data 1330 of the data container 1300 results in the processor circuit 550 executing the policy component 1345, causing the processor circuit 550 to request security data including one or more of an operator ID, a device ID, a private key and an indication of the security features of the computing device 500. Given that the computing device 500 does not incorporate a controller with an isolated processor circuit, the processor circuit 550 itself responds to the request by providing one or more of a device ID 532, an operator ID 533, a private key 535 and a function data 538, depending on what was requested. The policy component 1345 then compares the operator ID 533 and/or the device ID 532 to the ID data 1331, and determines whether the private key 535 is a match to the public key 1336.

As previously discussed, the computing device 500 does not provide as high a level of security as provided by the computing devices 100a-b and 300. However, as previously discussed, the environment component 545 does provide the virtual environment 555 in which sequences of instructions of the data container 1300 may be executed with some degree of protections in place. This lesser level of security may be indicated by the provision of the private key 535, if the data container 1300 includes a corresponding public key for which the private key 535 is a match. The private key 535 may have been provided with, or possibly generated by the environment component 545 as a mechanism to provide verification of its ability to provide the virtual environment 555. Depending on the access policy specified in the policy data 1335, verification of the provision of this lesser degree of security may be deemed acceptable to the same degree as the higher level of security provided in the computing device 300, such that similar access is granted to the operator of the computing device 500 (presuming that the operator of the computing devices 100a-b provided the data container 1300 to the operator of the computing device 500 with editing access similar to that provided to the operator of the computing device 300).

Alternatively, the access policy specified in the policy data 1335 may impose greater restrictions on editing of the protected data 1330 by the operator of the computing device 500 versus the operator of the computing device 300. By way of example, the policy component 1345 may require that editing be performed using only the editor component 1342 embedded within the data container 1300 to maintain tighter control over actions that may be taken during editing, and perhaps to more directly implement such features as locking access to the protected data 1330 (if not locking access to the entirety of the computing device 500) in response to the passage of a specified period of time during which no activity is detected on the part of the operator such that it is presumed the operator is no longer in the vicinity of the computing device 500.

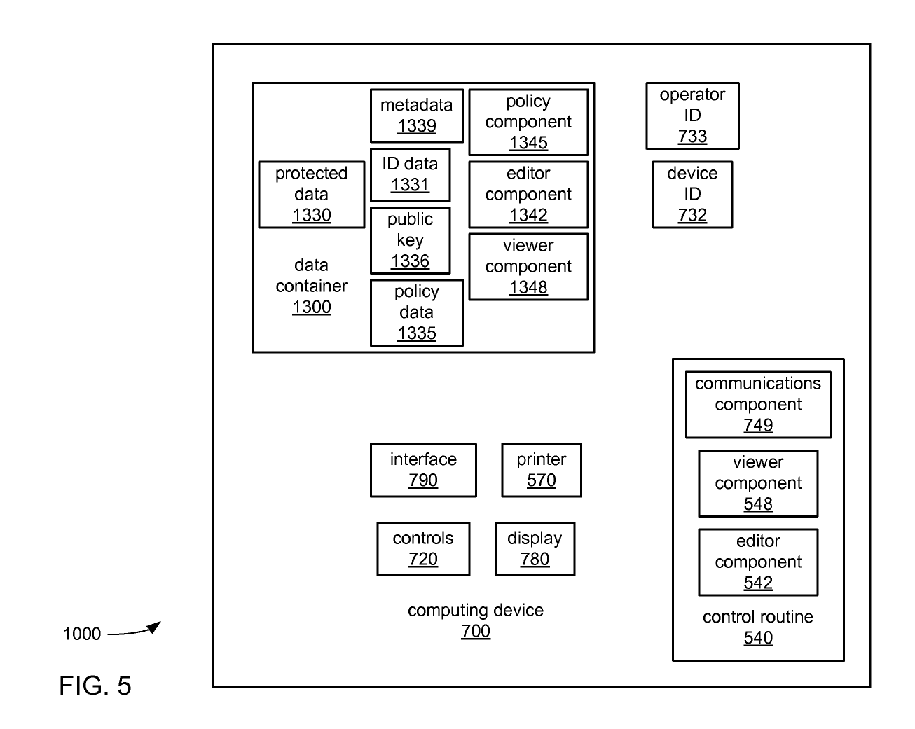

Turning briefly to FIG. 5, operation of the controls 720 of the computing device 700 to access the protected data 1330 of the data container 1300 results in the processor circuit 750 executing the policy component 1345, causing the processor circuit 750 to request security data including one or more of an operator ID, a device ID, a private key and an indication of the security features of the computing device 700. Given that the computing device 700 does not incorporate a controller with an isolated processor circuit or an environment component able to provide a virtual environment, the processor circuit 750 responds to the request by providing one or more of a device ID 732, an operator ID 733 and a function data 738, but does not provide a private key. The lack of either a controller to provide a hardware-supported virtual environment or an environment component to provide a software-based virtual environment results in the computing device 700 not being assigned a private key. The policy component 1345 then compares the operator ID 733 and/or the device ID 732 to the ID data 1331.

The lack of a private key from the processor circuit 750 in response to the request indicates to the policy component 1345 that the computing device 700 is likely not a trustworthy environment. As a result, even if the operator ID 733 is found to indicate an operator to whom the operator of the computing devices 100a-b intended to grant some form of access to the protected data 1330, the relative lack of security may cause the operator ID 733 to be deemed to be less trustworthy since it may be more likely to have been copied to the computing device 700 from another computing device.

As a result, the policy component 1345, under the direction of the access policy specified in the policy data 1335, may not provide access to the protected data 1330, or may provide only viewing access to the protected data 1330 with the restriction that only the viewer component 1348 may be used. Alternatively or additionally, the policy component 1345 may impose a time limit on access to the protected data 1330, such as a date on which access expires or a maximum number of hours or days during which the protected data 1330 may be accessed upon first access through the computing device 700.

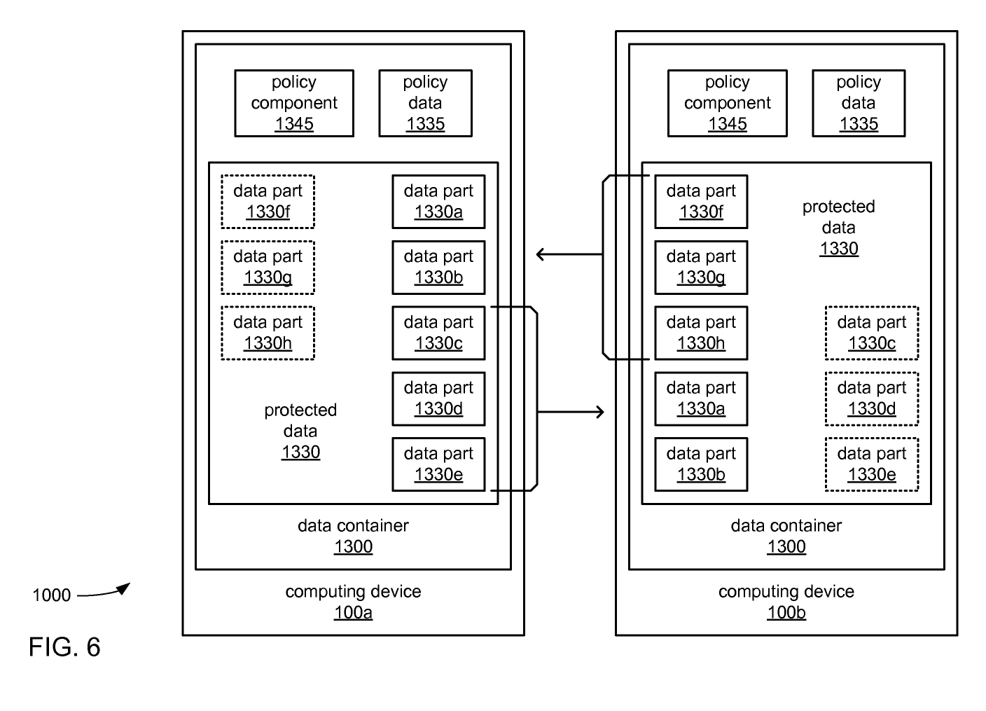

FIG. 6 illustrates a block diagram of synchronization between two copies of the data container 1300, perhaps performed by cooperation between the respective processors 150 of the two computing devices 100a and 100b via secure communications established between them as a result of becoming members of a common group, as previously described. More specifically, FIG. 6 illustrates an aggregation of subparts of the protected data 1330 added to each the two depicted copies of the data containers 1300, the aggregation arising from the synchronization process as a result of the computing devices 100a and 100b coming back into contact with each other after a period of not being in communication.

As depicted, the two copies of the data container 1300 were initially identical, with the protected data 1330 within both comprising data subparts 1330a and 1330b. Subsequently, the two copies of the data container 1300 were caused to diverge, with the protected data 1330 of each having different data subparts added. Specifically, data subparts 1330c, 1330d and 1330e were added to the protected data 1330 of the data container 1300 of the computing device 100a, and data subparts 1330f, 1330g and 1330h were added to the protected data 1330 of the data container 1300 of the computing device 100b. At a time following the additions of these data subparts to each of these versions of the protected data 1330, the data containers 1300 of each of the computing devices 100a and 100b are synchronized.

This synchronization may have occurred as a result of the processor circuits 150 of each of these computing devices detecting the other such that these two processor circuits were caused to cooperate to synchronize their data containers 1300 via secure communications directly between them. Alternatively, this synchronization may have occurred indirectly as a result of one or more other computing devices that are members of the same group to which the computing devices 100a-b also belong synchronizing there copies of the data container 1300 with the copies of each of the computing devices 100a and 100b. In such an indirect synchronization, the different copies of the data containers 1300 of each of the computing device 100a and 100b would propagate to one or more other computing devices with which the computing devices 100a and 100b have direct communication, a combining of the changes (e.g., the additions of different data subparts) would have occurred within one of those other computing devices, and then the copy of the data container 1300 incorporating all of those changes would propagate back towards each of the computing devices 100a and 100b.

Further, it may be that the access policy specified in the policy data 1335 dictates a change in the access granted to the protected data 1330 that is dependent upon the quantity of portions making up the protected data 1330, or upon some other measure of completeness of the protected data 1330. By way of example, where the protected data 1330 starts as little more than an empty form, the access policy may dictate that the protected data 1330 is accessible to a first group of persons (possibly a group of persons sharing the same operator ID) for purposes of enabling different ones of them to fill it in. However, at the point at which the form is fully filled in or possibly at the point at which the form is signed (presumably by someone who is certifying its completeness by doing so), the access policy may dictate that the now completed form is now accessible to a second group of persons and is no longer accessible to the first group of persons.

By way of another example, it may be that the protected data 1330 of the copies of the data container 1300 depicted in FIG. 6 is being added to over time with subparts of data collected from various sources, and that upon the addition of a sufficient quantity of data, the access policy specified in the policy data 1335 dictates that the type of access granted to the data and to whom may change. Specifically, the data subparts 1330a-h may each represent statistical information associated with a particular individual that are being gathered and assembled in the data 1330 for a subsequent analysis. The access policy of the policy data 1335 may dictate that access to each one of the data subparts 1330a-h is initially to be limited to the particular person who provides it, and that this access will be removed once a specified number of these data subparts have been added and a statistical analysis that aggregates the data subparts 1330a-h has been performed and added to the protected data 1330. At that time, access to a portion of the protected data 1330 comprising the statistical analysis will be widely granted, but little or no access will be permitted to the individual data subparts 1330a-h, thereby protecting that information.

In a variation on the aggregating of data, it may be that a change in a degree of access to one data container is changed by that data container detecting the presence of another data container comprising data of a related subject. It may be that the metadata 1339 of one data container is caused to be checked by the policy component 1345 of another to determine if the subjects are sufficiently similar as to provide an indication of the operator of the computing device on which both are stored having a legitimate purpose for accessing data related to a common subject. By way of example, a data container storing data concerning allergic conditions that may be somewhat person to one individual may be stored within a computing device of another individual also having such conditions such that there is already a data container stored therein storing data concerning that other individual's allergic conditions. Upon one of the data containers discovering the other, it may be that a comparison of metadata indicating similar subject matter serves as a trigger for the degree of access of one or both of the data containers being made less restrictive.

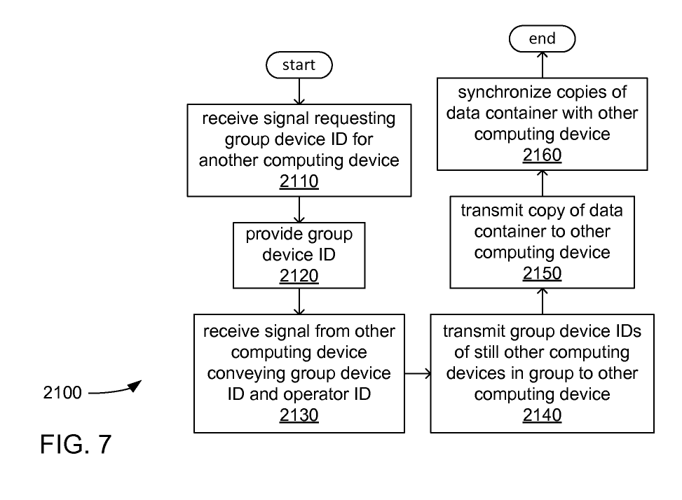

FIG. 7 illustrates one embodiment of a logic flow 2100. The logic flow 2100 may be representative of some or all of the operations executed by one or more embodiments described herein. More specifically, the logic flow 2100 may illustrate operations performed by the processor circuit 150 of one of the computing devices 100a or 100b in executing at least the control routine 140.

At 2110, a computing device (e.g., one of the computing devices 100a or 100b) receives a signal requesting a group device ID to be provided to another computing device (e.g., another of the computing devices 100a or 100b). As previously discussed, this signaling may be by operation of controls of the computing device (e.g., the controls 120), and the signal may be directly received by a processor circuit, or may be relayed to it by another processor circuit monitoring the controls.

At 2120, the computing device responds to the request by providing the group device ID. As previously discussed, provision of the group device ID may be performed by visually presenting it on a display of the computing device (e.g., the display 180), or may be through some other mechanism, such as spoken in an artificially generated voice.

At 2130, the computing device receives a signal from the other computing device in which the group device ID and an operator ID. As previously discussed, the operator ID is associated with the operator of both of these computing devices.

At 2140, in response to receiving the group device ID and an operator ID matching its own operator ID (e.g., associated with the same operator), the computing device transmits one or more group IDs of still other computing devices that are also members of the group to which the computing device (and now, also the other computing device) belongs.

At 2150, also in response to receiving the group device ID and the operator ID, the computing device transmits a copy of one or more data containers stored within the computing device to the other computing device.

At 2160, at a later time, these two computing devices that are now both members of the same group, synchronize their copies of the one or more data containers.

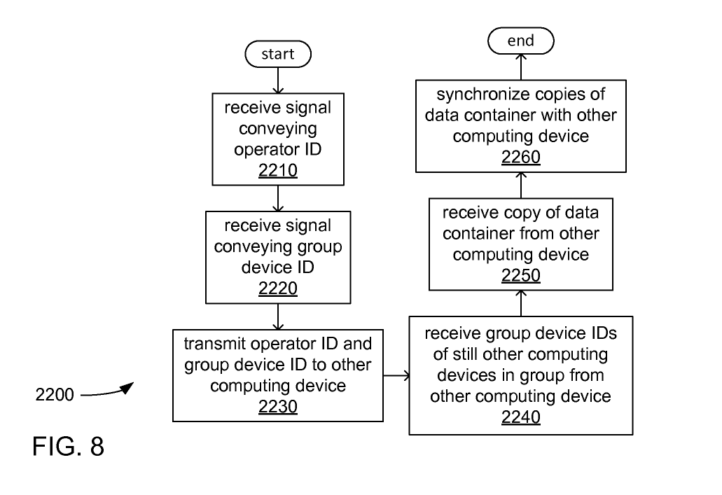

FIG. 8 illustrates one embodiment of a logic flow 2200. The logic flow 2200 may be representative of some or all of the operations executed by one or more embodiments described herein. More specifically, the logic flow 2200 may illustrate operations performed by the processor circuit 150 of one of the computing devices 100a or 100b in executing at least the control routine 140.

At 2210, a computing device (e.g., one of the computing devices 100a or 100b) receives a signal conveying an operator ID to it. As previously discussed, an operator of the computing devices 100a-b may be required to authenticate themselves to them prior to using them, and thus, that operator must provide an operator ID to each of them.

At 2220, the computing device receives a signal conveying a group device ID to it. As previously discussed, this signaling may be by operation of controls of the computing device (e.g., the controls 120), and the signal may be directly received by a processor circuit, or may be relayed to it by another processor circuit monitoring the controls.

At 2230, in response to receiving the operator ID and the group device ID, the computing device transmits both the operator ID and the group device ID to another computing device to join a group of computing devices to which the other computing device already belongs.

At 2240, the computing device receives group device IDs of still other computing devices that are also members of the group to which the computing device now belongs

At 2250, the computing device receives a copy of one or more data containers stored within the computing device to the other computing device.

At 2260, at a later time, these two computing devices that are now both members of the same group, synchronize their copies of the one or more data containers.

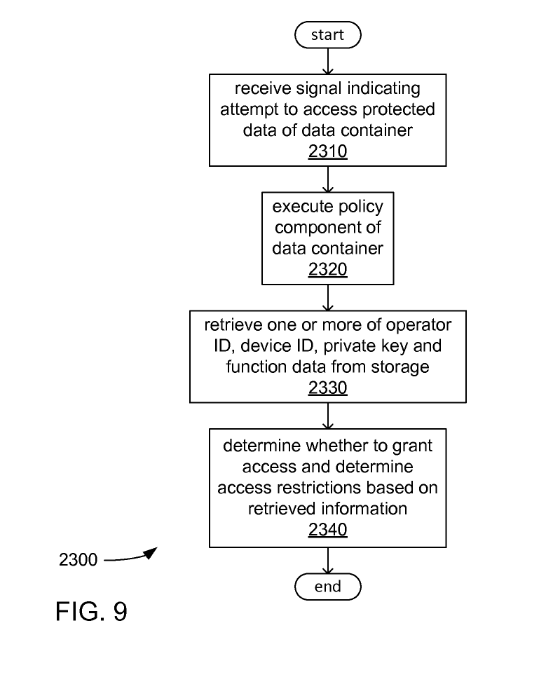

FIG. 9 illustrates one embodiment of a logic flow 2300. The logic flow 2300 may be representative of some or all of the operations executed by one or more embodiments described herein. More specifically, the logic flow 2300 may illustrate operations performed by one of the processor circuits 550 or 750 of a corresponding one of the computing devices 500 or 700.

At 2310, a computing device not comprising a controller (e.g., one of the computing devices 500 or 700) receives a signal indicating operation of its controls to attempt to access data of a data container stored in a storage of the computing device.

At 2320, as a result of the attempted access, a processor circuit of the computing device executes a sequence of instructions of the data container comprising a policy component controlled by a policy data specifying an access policy for the data of the data container.

At 2330, execution of that policy component results in the processor circuit seeking one or more of an operator ID associated with an operator of the computing device, a device ID, a private key assigned to the computing device, and function data specifying security features of the computing device. Given that the computing device does not comprise a controller, the processor circuit retrieves one or more of these pieces of information from the storage of the computing device itself.

At 2340, execution of that policy component results in the processor circuit determining whether to grant access to the data of the data container and to determine what restrictions to impose based on the retrieved pieces of information.

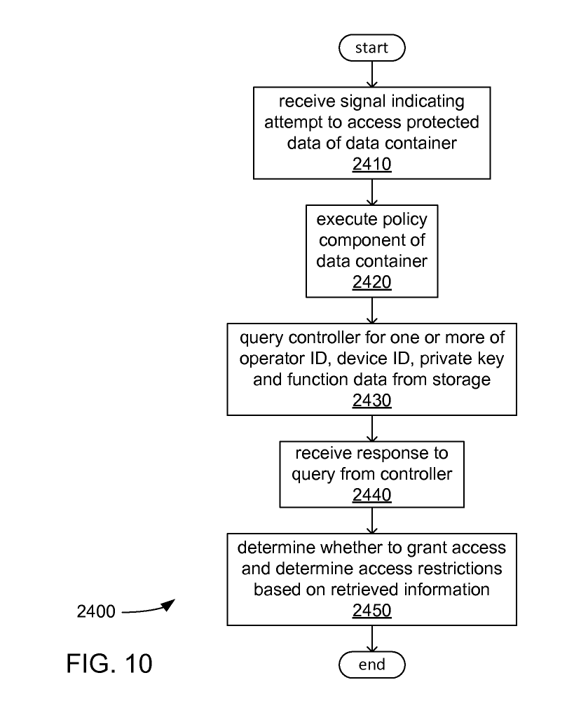

FIG. 10 illustrates one embodiment of a logic flow 2400. The logic flow 2400 may be representative of some or all of the operations executed by one or more embodiments described herein. More specifically, the logic flow 2400 may illustrate operations performed by one of the processor circuits 150 or 350 of a corresponding one of the computing devices 100a-b or 300.

At 2410, a computing device that comprises a controller (e.g., one of the computing devices 100a-b or 300) receives a signal indicating operation of its controls to attempt to access data of a data container stored in a storage of the computing device.

At 2420, as a result of the attempted access, a processor circuit of the computing device executes a sequence of instructions of the data container comprising a policy component controlled by a policy data specifying an access policy for the data of the data container.

At 2430, execution of that policy component results in the processor circuit seeking one or more of an operator ID associated with an operator of the computing device, a device ID, a private key assigned to the computing device, and function data specifying security features of the computing device. As a result of the computing device comprising a controller, the processor circuit is provided one or more of these pieces of information by the controller, an isolated processor circuit of the controller having retrieved one or more of these pieces of information from a storage of the controller.

At 2440, execution of that policy component results in the processor circuit determining whether to grant access to the data of the data container and to determine what restrictions to impose based on the retrieved pieces of information.

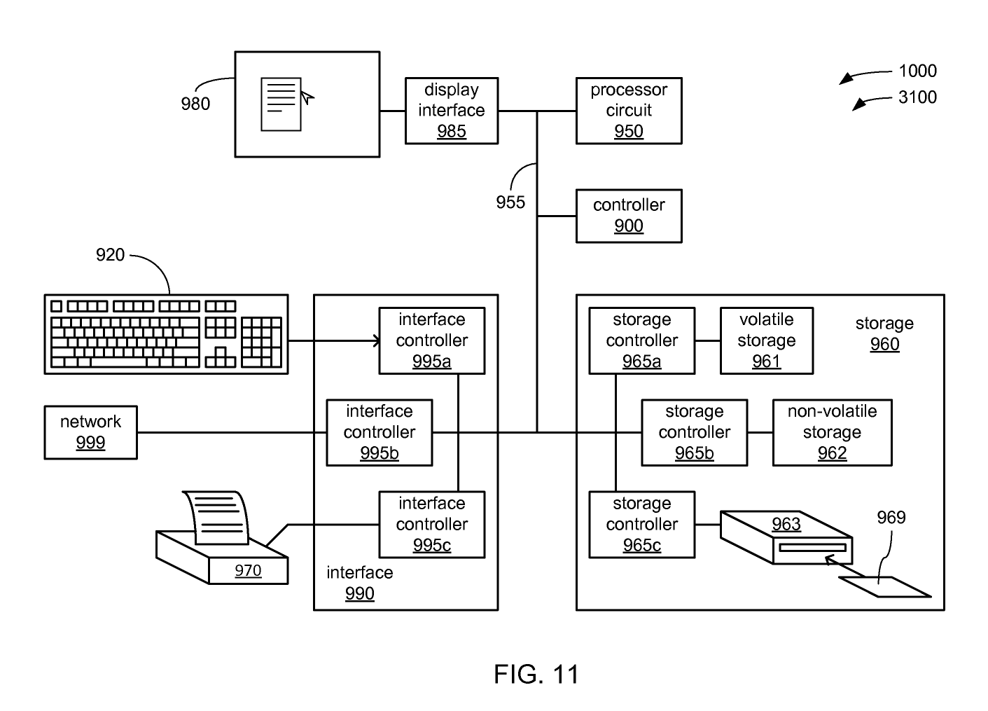

FIG. 11 illustrates an embodiment of an exemplary processing architecture 3100 suitable for implementing various embodiments as previously described. More specifically, the processing architecture 3100 (or variants thereof) may be implemented as part of one or more of the computing devices 100a-b, 300, 500 and 700. It should be noted that components of the processing architecture 3100 are given reference numbers in which the last two digits correspond to the last two digits of reference numbers of components earlier depicted and described as part of each of the computing devices 100a-b, 300, 500 and 700. This is done as an aid to correlating such components of whichever ones of the computing devices 100, 300, 500 and 700 may employ this exemplary processing architecture in various embodiments.

The processing architecture 3100 includes various elements commonly employed in digital processing, including without limitation, one or more processors, multi-core processors, co-processors, memory units, chipsets, controllers, peripherals, interfaces, oscillators, timing devices, video cards, audio cards, multimedia input/output (I/O) components, power supplies, etc. As used in this application, the terms “system” and “component” are intended to refer to an entity of a computing device in which digital processing is carried out, that entity being hardware, a combination of hardware and software, software, or software in execution, examples of which are provided by this depicted exemplary processing architecture. For example, a component can be, but is not limited to being, a process running on a processor circuit, the processor circuit itself, a storage device (e.g., a hard disk drive, multiple storage drives in an array, etc.) that may employ an optical and/or magnetic storage medium, an software object, an executable sequence of instructions, a thread of execution, a program, and/or an entire computing device (e.g., an entire computer). By way of illustration, both an application running on a server and the server can be a component. One or more components can reside within a process and/or thread of execution, and a component can be localized on one computing device and/or distributed between two or more computing devices. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to one or more signal lines. Each message may be a signal or a plurality of signals transmitted either serially or substantially in parallel.

As depicted, in implementing the processing architecture 3100, a computing device comprises at least a processor circuit 950, a storage 960, an interface 990 to other devices, and coupling 955. As will be explained, depending on various aspects of a computing device implementing the processing architecture 3100, including its intended use and/or conditions of use, such a computing device may further comprise additional components, such as without limitation, a display interface 985 or a controller 900.

The coupling 955 is comprised of one or more buses, point-to-point interconnects, transceivers, buffers, crosspoint switches, and/or other conductors and/or logic that communicatively couples at least the processor circuit 950 to the storage 960. The coupling 955 may further couple the processor circuit 950 to one or more of the interface 990 and the display interface 985 (depending on which of these and/or other components are also present). With the processor circuit 950 being so coupled by couplings 955, the processor circuit 950 is able to perform the various ones of the tasks described at length, above, for whichever ones of the computing devices 100a-b, 300, 500 and 700 implement the processing architecture 3100. The coupling 955 may be implemented with any of a variety of technologies or combinations of technologies by which signals are optically and/or electrically conveyed. Further, at least portions of couplings 955 may employ timings and/or protocols conforming to any of a wide variety of industry standards, including without limitation, Accelerated Graphics Port (AGP), CardBus, Extended Industry Standard Architecture (E-ISA), Micro Channel Architecture (MCA), NuBus, Peripheral Component Interconnect (Extended) (PCI-X), PCI Express (PCI-E), Personal Computer Memory Card International Association (PCMCIA) bus, HyperTransport™, QuickPath, and the like.

As previously discussed, the processor circuit 950 (corresponding to one or more of the processor circuits 150, 250, 350, 450, 550 and 750) may comprise any of a wide variety of commercially available processors, employing any of a wide variety of technologies and implemented with one or more cores physically combined in any of a number of ways.

As previously discussed, the storage 960 (corresponding to one or more of the storages 160, 260, 360, 460, 560 and 760) may comprise one or more distinct storage devices based on any of a wide variety of technologies or combinations of technologies. More specifically, as depicted, the storage 960 may comprise one or more of a volatile storage 961 (e.g., solid state storage based on one or more forms of RAM technology), a non-volatile storage 962 (e.g., solid state, ferromagnetic or other storage not requiring a constant provision of electric power to preserve their contents), and a removable media storage 963 (e.g., removable disc or solid state memory card storage by which information may be conveyed between computing devices). This depiction of the storage 960 as possibly comprising multiple distinct types of storage is in recognition of the commonplace use of more than one type of storage device in computing devices in which one type provides relatively rapid reading and writing capabilities enabling more rapid manipulation of data by the processor circuit 950 (but possibly using a “volatile” technology constantly requiring electric power) while another type provides relatively high density of non-volatile storage (but likely provides relatively slow reading and writing capabilities).

Given the often different characteristics of different storage devices employing different technologies, it is also commonplace for such different storage devices to be coupled to other portions of a computing device through different storage controllers coupled to their differing storage devices through different interfaces. By way of example, where the volatile storage 961 is present and is based on RAM technology, the volatile storage 961 may be communicatively coupled to coupling 955 through a storage controller 965a providing an appropriate interface to the volatile storage 961 that perhaps employs row and column addressing, and where the storage controller 965a may perform row refreshing and/or other maintenance tasks to aid in preserving information stored within the volatile storage 961. By way of another example, where the non-volatile storage 962 is present and comprises one or more ferromagnetic and/or solid-state disk drives, the non-volatile storage 962 may be communicatively coupled to coupling 955 through a storage controller 965b providing an appropriate interface to the non-volatile storage 962 that perhaps employs addressing of blocks of information and/or of cylinders and sectors. By way of still another example, where the removable media storage 963 is present and comprises one or more optical and/or solid-state disk drives employing one or more pieces of removable machine-readable storage media 969, the removable media storage 963 may be communicatively coupled to coupling 955 through a storage controller 965c providing an appropriate interface to the removable media storage 963 that perhaps employs addressing of blocks of information, and where the storage controller 965c may coordinate read, erase and write operations in a manner specific to extending the lifespan of the machine-readable storage media 969.

One or the other of the volatile storage 961 or the non-volatile storage 962 may comprise an article of manufacture in the form of a machine-readable storage media on which a routine comprising a sequence of instructions executable by the processor circuit 950 may be stored, depending on the technologies on which each is based. By way of example, where the non-volatile storage 962 comprises ferromagnetic-based disk drives (e.g., so-called “hard drives”), each such disk drive typically employs one or more rotating platters on which a coating of magnetically responsive particles is deposited and magnetically oriented in various patterns to store information, such as a sequence of instructions, in a manner akin to removable storage media such as a floppy diskette. By way of another example, the non-volatile storage 962 may comprise banks of solid-state storage devices to store information, such as sequences of instructions, in a manner akin to a compact flash card. Again, it is commonplace to employ differing types of storage devices in a computing device at different times to store executable routines and/or data. Thus, a routine comprising a sequence of instructions to be executed by the processor circuit 950 may initially be stored on the machine-readable storage media 969, and the removable media storage 963 may be subsequently employed in copying that routine to the non-volatile storage 962 for longer term storage not requiring the continuing presence of the machine-readable storage media 969 and/or the volatile storage 961 to enable more rapid access by the processor circuit 950 as that routine is executed.

As previously discussed, the interface 990 (corresponding to one or more of the interfaces 190, 390, 590 and 790) may employ any of a variety of signaling technologies corresponding to any of a variety of communications technologies that may be employed to communicatively couple a computing device to one or more other devices. Again, one or both of various forms of wired or wireless signaling may be employed to enable the processor circuit 950 to interact with input/output devices (e.g., the depicted example keyboard 920 or printer 970) and/or other computing devices, possibly through a network (e.g., the network 999) or an interconnected set of networks. In recognition of the often greatly different character of multiple types of signaling and/or protocols that must often be supported by any one computing device, the interface 990 is depicted as comprising multiple different interface controllers 995a, 995b and 995c. The interface controller 995a may employ any of a variety of types of wired digital serial interface or radio frequency wireless interface to receive serially transmitted messages from user input devices, such as the depicted keyboard 920 (perhaps corresponding to one or more of the controls 120, 320, 520 and 720). The interface controller 995b may employ any of a variety of cabling-based or wireless signaling, timings and/or protocols to access other computing devices through the depicted network 999 (perhaps a network comprising one or more links, smaller networks, or perhaps the Internet). The interface 995c may employ any of a variety of electrically conductive cabling enabling the use of either serial or parallel signal transmission to convey data to the depicted printer 970. Other examples of devices that may be communicatively coupled through one or more interface controllers of the interface 990 include, without limitation, microphones, remote controls, stylus pens, card readers, finger print readers, virtual reality interaction gloves, graphical input tablets, joysticks, other keyboards, retina scanners, the touch input component of touch screens, trackballs, various sensors, laser printers, inkjet printers, mechanical robots, milling machines, three-dimensional printers, etc.

Where a computing device is communicatively coupled to (or perhaps, actually comprises) a display (e.g., the depicted example display 980, corresponding to one or more of the displays 180, 380, 580 and 780), such a computing device implementing the processing architecture 3100 may also comprise the display interface 985. Although more generalized types of interface may be employed in communicatively coupling to a display, the somewhat specialized additional processing often required in visually displaying various forms of content on a display, as well as the somewhat specialized nature of the cabling-based interfaces used, often makes the provision of a distinct display interface desirable. Wired and/or wireless signaling technologies that may be employed by the display interface 985 in a communicative coupling of the display 980 may make use of signaling and/or protocols that conform to any of a variety of industry standards, including without limitation, any of a variety of analog video interfaces, Digital Video Interface (DVI), DisplayPort, etc.

Further, where the display interface 985 is present in a computing device implementing the processing architecture 3100, an ocular tracker 981 may also be coupled to the interface 985 to track ocular movements of at least one eye of a person viewing the display 980. Alternatively, the ocular tracker 981 may be incorporated into the computer architecture 3100 in some other manner. The ocular tracker 981 may employ any of a variety of technologies to monitor ocular movements, including and not limited to, infrared light reflection from the cornea.

More generally, the various elements of the computing devices 100, 300, 500 and 700 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. The detailed disclosure now turns to providing examples that pertain to further embodiments. The examples provided below are not intended to be limiting.

An example of an apparatus comprises a processor circuit and a storage communicatively coupled to the processor circuit and arranged to store a first sequence of instructions. The first sequence of instructions is operative on the processor circuit to receive a signal that indicates an access to a data container stored in the storage and comprising a protected data and a second sequence of instructions; and execute the second sequence of instructions, the second sequence of instructions operative on the processor circuit to examine security data stored in the storage and determine whether to grant access to the protected data based on the examination.

The above example of an apparatus in which the apparatus comprises manually-operable controls, and the signal indicates operation of the controls to access the protected data.

Either of the above examples of an apparatus in which the second sequence of instructions is operative on the processor circuit to impose a time limit on access to the protected data based on the examination, the time limit comprising one of a specified date beyond which access to the protected data is no longer granted and a specified amount of time from a first access to the protected data beyond which access to the protected data is no longer granted.

Any of the above examples of an apparatus in which the first sequence of instructions operative on the processor circuit to provide a virtual environment to support execution of the second sequence of instructions and to prevent the processor circuit from performing an action that relates to the protected data.

Any of the above examples of an apparatus in which the action comprises one of printing the protected data, copying the protected data, capturing a screen image of a visual presentation of the protected data, and allowing the protected data to be visually presented following the elapsing of a specified period of time during which no signal indicative of continued presence of the operator in the vicinity of the apparatus has been received.

Any of the above examples of an apparatus in which the security data comprises one of an operator ID that identifies an operator associated with the apparatus, a device ID that uniquely identifies the apparatus, a private key, and a function data that indicates a security feature of the apparatus.

Any of the above examples of an apparatus in which determining whether to grant access to the protected data based on the examination comprises determining whether the operator is authorized to access the protected data.

Any of the above examples of an apparatus in which the data container comprises a public key and determining whether to grant access to the protected data based on the examination comprises determining if the private key is a match to the public key.

Any of the above examples of an apparatus in which determining whether to grant access to the protected data based on the examination comprises determining whether to grant access to the protected data based on the security feature.

An example of another apparatus comprises a first processor circuit, a second processor circuit, a first storage communicatively coupled to the first processor circuit and arranged to store a first sequence of instructions, and a second storage communicatively coupled to the second processor circuit and arranged to store a third sequence of instructions. The first sequence of instructions is operative on the first processor circuit to receive a signal that indicates an access to a data container stored in the first storage and comprising a protected data and a second sequence of instructions; and execute the second sequence of instructions, the second sequence of instructions operative on the first processor circuit to request security data from the second processor circuit, and determine whether to grant access to the protected data based on the security data. The second sequence of instructions is operative on the second processor circuit to receive the request from the first processor circuit, and provide the security data to the first processor circuit in response to the request.

The above example of another apparatus in which the apparatus comprises manually-operable controls, and the signal indicates operation of the controls to access the protected data.

Either of the above examples of another apparatus in which the third sequence of instructions is operative on the second processor circuit to provide a virtual environment to support execution of the second sequence of instructions by the first processor circuit and to prevent the first processor circuit from performing an action compromising the protected data.

Any of the above examples of another apparatus in which the action comprises one of printing the protected data, copying the protected data, capturing a screen image of a visual presentation of the protected data, and allowing the protected data to be visually presented following the elapsing of a specified period of time during which no signal indicative of continued presence of the operator in the vicinity of the apparatus has been received.

Any of the above examples of another apparatus in which the security data comprises one of an operator ID that identifies an operator associated with the apparatus, a device ID that uniquely identifies the apparatus, a private key, and a function data that indicates a security feature of the apparatus.

Any of the above examples of another apparatus in which determining whether to grant access to the protected data based on the examination comprises determining whether the operator is authorized to access the protected data.

Any of the above examples of another apparatus in which the data container comprises a public key and determining whether to grant access to the protected data based on the examination comprises determining if the private key is a match to the public key.

Any of the above examples of another apparatus in which determining whether to grant access to the protected data based on the examination comprises determining whether to grant access to the protected data based on the security feature.

Any of the above examples of another apparatus in which the apparatus comprises an interface operative to communicatively couple the first processor circuit to a network, and the third sequence of instructions is operative on the second processor circuit to receive a signal via the network from a computing device that conveys an operator ID that identifies an operator associated with the computing device and a group device ID that uniquely identifies the computing device; determine whether the computing device is a member of a group of which the apparatus is a member; and enable transmission of a copy of the data container to the computing device via the network in response to the determination.

Any of the above examples of another apparatus in which the first sequence of instructions is operative on the first processor circuit to signal the computing device to synchronize the data container with the copy of the data container via the network.

An example of a computer-implemented method comprises receiving a signal indicating an access to a data container stored in a storage of a first computing device and comprising a protected data and a sequence of instructions; and executing the sequence of instructions. The sequence of instructions is operative on a processor circuit of the first computing device to examine security data associated with the first computing device and stored in the storage; and determine whether to grant access to the protected data based on the examination.

The above example of a computer-implemented method comprises imposing a time limit on access to the protected data based on the examination, the time limit comprising one of a specified date beyond which access to the protected data is no longer granted and a specified amount of time from a first access to the protected beyond which access to the protected data is no longer granted.

Either of the above examples of a computer-implemented method in which the method comprises providing a virtual environment to support execution of the sequence of instructions and to prevent the processor circuit from performing an action compromising the protected data.

Any of the above examples of a computer-implemented method in which the action comprises one of printing the protected data, copying the protected data, capturing a screen image of a visual presentation of the protected data, and allowing the protected data to be visually presented following the elapsing of a specified period of time during which no signal indicative of continued presence of the operator in the vicinity of the first computing device has been received.

Any of the above examples of a computer-implemented method in which the method comprises receiving a signal via a network from a second computing device conveying an operator ID identifying an operator associated with the second computing device and a group device ID uniquely identifying the second computing device; determining whether the second computing device is a member of a group of which the first computing device is a member; and transmitting a copy of the data container to the second computing device via the network in response to the determination.

Any of the above examples of a computer-implemented method in which the method comprises signaling the second computing device to synchronize the data container with the copy of the data container via the network.

An example of at least one machine-readable storage medium comprises a first sequence of instructions that when executed by a computing device, causes the computing device to receive a signal indicating an access to a data container stored in a storage of the computing device and comprising a protected data and a second sequence of instructions, and execute the second sequence of instructions. The second sequence of instructions is operative on the processor circuit to examine security data associated with the computing device and stored in the storage and determine whether to grant access to the protected data based on the examination.

The above example of at least one machine-readable storage medium in which the computing device is caused to provide a virtual environment to support execution of the second sequence of instructions and to prevent the processor circuit from performing an action compromising the protected data.

Either of the above examples of at least one machine-readable storage medium in which the action comprises one of printing the protected data, copying the protected data, capturing a screen image of a visual presentation of the protected data, and allowing the protected data to be visually presented following the elapsing of a specified period of time during which no signal indicative of continued presence of the operator in the vicinity of the computing device has been received.

Any of the above examples of at least one machine-readable storage medium in which the security data comprises one of an operator ID identifying an operator associated with the computing device, a device ID uniquely identifying the computing device, a private key, and a function data indicating a security feature of the computing device.

Any of the above examples of at least one machine-readable storage medium in which the data container comprises a public key and determining whether to grant access to the protected data based on the examination comprises determining if the private key is a match to the public key.

1. An apparatus comprising:
a processor circuit; and
a storage communicatively coupled to the processor circuit and arranged to store a first sequence of instructions operative on the processor circuit to:
receive a signal that indicates an access to a data container stored in the storage and comprising a protected data and a second sequence of instructions; and
execute the second sequence of instructions, the second sequence of instructions operative on the processor circuit to:
examine security data stored in the storage; and
determine whether to grant access to the protected data based at least in part on the examination.

2. The apparatus of claim 1, comprising manually-operable controls, and the signal indicates operation of the controls to access the protected data.

3. The apparatus of claim 1, the second sequence of instructions operative on the processor circuit to impose a time limit on access to the protected data based at least in part on the examination, the time limit comprising one of a specified date beyond which access to the protected data is no longer granted or a specified amount of time from a first access to the protected data beyond which access to the protected data is no longer granted.

4. The apparatus of claim 1, the first sequence of instructions operative on the processor circuit to provide a virtual environment to support execution of the second sequence of instructions and to prevent the processor circuit from performing an action that relates to the protected data.

5. The apparatus of claim 4, the action comprising one of printing the protected data, copying the protected data, capturing a screen image of a visual presentation of the protected data, or allowing the protected data to be visually presented following the elapsing of a specified period of time during which no signal indicative of continued presence of an operator in the vicinity of the apparatus has been received.

6. The apparatus of claim 1, the security data comprising at least one of an operator ID that identifies an operator associated with the apparatus, a device ID that uniquely identifies the apparatus, a private key, or a function data that indicates a security feature of the apparatus.

7. The apparatus of claim 6, wherein the determination of whether to grant access to the protected data is based at least in part on the examination comprises determining whether the operator is authorized to access the protected data.

8. The apparatus of claim 6, the data container comprising a public key and determining whether to grant access to the protected data based at least in part on the examination comprises determining if the private key is a match to the public key.

9. The apparatus of claim 8, the security data comprising a function data that indicates a security feature of the apparatus, and determining whether to grant access to the protected data based at least in part on the examination comprises determining whether to grant access to the protected data based on the security feature.

10. An apparatus comprising:
a first processor circuit;
a second processor circuit;
a first storage communicatively coupled to the first processor circuit and arranged to store a first sequence of instructions operative on the first processor circuit to:
receive a signal that indicates an access to a data container stored in the first storage and comprising a protected data and a second sequence of instructions; and
execute the second sequence of instructions, the second sequence of instructions operative on the first processor circuit to request security data from the second processor circuit, and determine whether to grant access to the protected data based on the security data; and
a second storage communicatively coupled to the second processor circuit and arranged to store a third sequence of instructions operative on the second processor circuit to receive the request from the first processor circuit, and provide the security data to the first processor circuit in response to the request.

11. The apparatus of claim 10, comprising manually-operable controls, and the signal indicates operation of the controls to access the protected data.

12. The apparatus of claim 10, wherein the third sequence of instructions is operative on the second processor circuit to provide a virtual environment to support execution of the second sequence of instructions by the first processor circuit and to prevent the first processor circuit from performing an action compromising the protected data.

13. The apparatus of claim 12, wherein the action comprises one of printing the protected data, copying the protected data, capturing a screen image of a visual presentation of the protected data, and allowing the protected data to be visually presented following the elapsing of a specified period of time during which no signal indicative of continued presence of an operator in the vicinity of the apparatus has been received.

14. The apparatus of claim 10, wherein the security data comprises at least one of an operator ID that identifies an operator associated with the apparatus, a device ID that uniquely identifies the apparatus, a private key, or a function data that indicates a security feature of the apparatus.

15. The apparatus of claim 14, wherein the determination of whether to grant access to the protected data comprises determining whether the operator is authorized to access the protected data.

16. The apparatus of claim 14, the data container comprising a public key and determining whether to grant access to the protected data comprises determining if the private key is a match to the public key.

17. The apparatus of claim 16, the security data comprising a function data that indicates a security feature of the apparatus, and determining whether to grant access to the protected data comprises determining whether to grant access to the protected data based on the security feature.

18. The apparatus of claim 10, comprising an interface operative to communicatively couple the first processor circuit to a network, the third sequence of instructions operative on the second processor circuit to:
receive a signal via the network from a computing device that conveys an operator ID that identifies an operator associated with the computing device and a group device ID that uniquely identifies the computing device;
determine whether the computing device is a member of a group of which the apparatus is a member; and
enable transmission of a copy of the data container to the computing device via the network in response to the determination.

19. The apparatus of claim 18, wherein the first sequence of instructions is operative on the first processor circuit to signal the computing device to synchronize the data container with the copy of the data container via the network.

20. A computer-implemented method comprising:
receiving a signal indicating an access to a data container stored in a storage of a first computing device and comprising a protected data and a sequence of instructions; and
executing the sequence of instructions, the sequence of instructions operative on a processor circuit of the first computing device to:
examine security data associated with the first computing device and stored in the storage; and
determine whether to grant access to the protected data based at least in part on the examination.

21. The computer-implemented method of claim 20, comprising imposing a time limit on access to the protected data based at least in part on the examination, the time limit comprising one of a specified date beyond which access to the protected data is no longer granted or a specified amount of time from a first access to the protected data beyond which access to the protected data is no longer granted.

22. The computer-implemented method of claim 20, comprising providing a virtual environment to support execution of the sequence of instructions and to prevent the processor circuit from performing an action compromising the protected data.

23. The computer-implemented method of claim 22, wherein the action comprises one of printing the protected data, copying the protected data, capturing a screen image of a visual presentation of the protected data, and allowing the protected data to be visually presented following the elapsing of a specified period of time during which no signal indicative of continued presence of the operator in the vicinity of the first computing device has been received.

24. The computer-implemented method of claim 20, comprising
receiving a signal via a network from a second computing device conveying an operator ID identifying an operator associated with the second computing device and a group device ID uniquely identifying the second computing device;
determining whether the second computing device is a member of a group of which the first computing device is a member; and
transmitting a copy of the data container to the second computing device via the network in response to the determination.

25. The computer-implemented method of claim 24, comprising signaling the second computing device to synchronize the data container with the copy of the data container via the network.

26. At least one machine-readable storage medium comprising a first sequence of instructions that when executed by a computing device, causes the computing device to:
receive a signal indicating an access to a data container stored in a storage of the computing device and comprising a protected data and a second sequence of instructions; and
execute the second sequence of instructions, the second sequence of instructions operative on the processor circuit to:
examine security data associated with the computing device and stored in the storage; and
determine whether to grant access to the protected data based at least in part on the examination.

27. The at least one machine-readable storage medium of claim 26, the computing device caused to provide a virtual environment to support execution of the second sequence of instructions and to prevent the processor circuit from performing an action compromising the protected data.

28. The at least one machine-readable storage medium of claim 27, wherein the action comprises one of printing the protected data, copying the protected data, capturing a screen image of a visual presentation of the protected data, or allowing the protected data to be visually presented following the elapsing of a specified period of time during which no signal indicative of continued presence of the operator in the vicinity of the computing device has been received.

29. The at least one machine-readable storage medium of claim 26, the security data comprising at least one of an operator ID identifying an operator associated with the computing device, a device ID uniquely identifying the computing device, a private key, or a function data indicating a security feature of the computing device.

30. The at least one machine-readable storage medium of claim 29, the data container comprising a public key and determining whether to grant access to the protected data based at least in part on the examination comprises determining if the private key is a match to the public key.
